(19) United States
(12) Patent Application Publication
(10) Pub. No.: US 2005/0060305 A1
(43) Pub. Date: Mar. 17, 2005

(54) System and method for the computer-assisted identification of drugs and indications

(75) Inventors: Andrew Hopkins, Sandwich (GB); Lee Harland, Sandwich (GB); Jerry Lanfear, Sandwich (GB); Colin Groom, Burwell (GB); Ian Parsons, Sandwich (GB); Tony Parsons, Sandwich (GB); Mark Zaretti, Sandwich (GB); Mark Burfoot, St. Louis, MO (US); Lee Beeley, Sandwich (GB)

Correspondence Address: CONNOLLY BOVE LODGE & HUTZ, LLP, P O BOX 2207, WILMINGTON, DE, 19899, US

(73) Assignee: Pfizer Inc., New York, NY (US)

(21) Appl. No.: 10/943,042

(22) Filed: Sep. 15, 2004

Related U.S. Application Data
(60) Provisional application No. 60/512,382, filed on Oct. 16, 2003.

(30) Foreign Application Priority Data
Sep. 16, 2003 (GB) UK 0321708.0

(51) Int. Cl. G06F 17/60

(52) U.S. Cl. 707/3; 600/300; 705/2; 706/46

(57) ABSTRACT

A pharmaceutical knowledge base is provided that contains multiple information items stored in at least one computer. Pharmaceutical knowledge is represented in a multi-dimensional coordinate space having at least first, second and third axes, where the first axis pertains to diseases, the second axis pertains to targets, and the third axis pertains to drug compounds. Pharmaceutical knowledge may be mapped into the multi-dimensional coordinate space by assigning each information item one or more locations in the space, dependent upon the data contained within the information item. This mapping may then be used to reveal hitherto unappreciated connections between the axes, such as the potential use of a particular compound or target for treating a certain disease.

### FIELD OF THE INVENTION

The present invention relates to the use of computers to assist in the identification of drugs, including the determination of further indications for existing drugs, and for other pharmaceutical investigations.

### BACKGROUND OF THE INVENTION

The development of new drugs has tended to follow the conventional pattern of scientific and medical research. Thus initially a disorder, such as an illness, symptom, syndrome or disease, is discovered and investigated, thereby permitting characterisation of the disorder in terms of the symptoms that it exhibits. Next an attempt is made to understand the metabolic and biochemical pathways underlying the disease. Typically such pathways involve one or more proteins, which in turn are coded by corresponding genes in the human genome (or in the genome of an infectious organism, if relevant).

Once the protein(s) involved in a disorder have been identified, attempts are made to find compounds (i.e. drug candidates) that bind to a relevant protein. The intention is to discover a drug that modifies the action of the protein in such a manner as to treat, rectify or at least alleviate the disorder, such as by masking undesired symptoms, or by managing a disorder. (Most drugs act by modifying the properties of a protein directly, although drugs can also work in other ways, such as by binding to DNA, RNA, fatty acids, or carbohydrates, or by catalysing modifications of these chemicals).

For example, a particular illness may be attributed to a change in the concentration in the body of a certain substance outside the normal limits. One possible counter to this problem might be to find a drug that is active against a protein responsible for making the substance, so as to modify the endogenous manufacturing process, and thereby alter the level of the substance in the human body. Alternatively, there may be a disposal or buffering process in the body, responsible for degrading or removing the substance from the human body. If a drug can find a protein target to suppress this disposal or buffering process, then this may also have the desired effect of altering the level of the substance in the body. Another strategy could be to design a compound to mimic the effect of the natural substance, or alternatively to administer the natural substrate directly to the patient from an exogenous source.

In the above drug development procedure, the initial discovery of a disease or illness is generally performed by health researchers and clinicians. Pharmaceutical companies are primarily involved in the two subsequent steps, namely identifying potential drug targets based on the biochemistry of a disorder, and then producing suitable drug candidates that are active against such targets. This work is often very challenging, involving many highly trained scientists, and with no certainty of a positive outcome being obtained.

Furthermore, even after a candidate drug has been identified from such research, it still has to survive several further phases of clinical evaluation and development before it can be marketed as a treatment for the relevant disorder. In particular, a series of trials must be performed to demonstrate the safety and efficacy of the drug. These trials are typically arranged in three phases, with phase one addressing toxicology and other safety issues, phase two addressing efficacy in relatively small-scale clinical trials, and then phase three looking at larger-scale clinical trials. The data obtained from this testing is submitted to a body such as the Food and Drugs Administration (FDA) in the United States, the Medicines Control Agency (MCA) in the United Kingdom, the European Medicines Evaluation Agency (EMEA) in the European Union, or the Pharmaceutical and Medical Devices Evaluation Center (PMDEC) in Japan, in order to obtain marketing approval of the drug. The widespread clinical testing necessary for obtaining approval from a regulatory body means that marketing approval may not be obtained until many years after the initial identification of a candidate compound.

The entire drug discovery and development process is therefore very expensive. It has been estimated that the expenditure on research and development followed by the clinical testing for taking a new drug through to market might typically be in the region of $800 million. Of course, there are significant costs associated with work on drug candidates that never survive to marketing, whether because of safety or efficacy concerns or due to other considerations. The magnitude of drug development costs impacts the number and nature of drug research projects that the pharmaceutical industry can support.

There have been various attempts to improve the efficiency of the drug discovery and development procedure by applying large-scale computing technology. One approach has been to try to exploit the bioinformatics tools and infrastructure used to sequence and analyse the human genome. In particular, the Human Genome Project has identified and sequenced approximately 25,000 genes in the human genome, along with their corresponding proteins. This has significantly improved the process of target identification for drug discovery purposes. For example, the use of computationally intensive sequence similarity algorithms (such as BLAST) can search the entire human genome to identify relationships in sequences of amino acids between an unknown protein and various known proteins. Such similar or shared sequences of amino acids may indicate possible homologies, and therefore give clues as to the behaviour, structure or functionality of the unknown protein. In addition, it may be possible to estimate the likelihood of finding an effective drug against an unknown protein, again based on homology with other proteins having a common or similar amino acid sequence.

Another area in which the use of computing power is being introduced to help the drug development process is the provision of in silico cellular models. Although these are still largely in their infancy, it is hoped that such models can be used to simulate the behaviour of cells. These simulations can then lead to a better understanding of a disorder, such as by mimicking the effect of an excess or deficit of a particular protein. In addition, such models may be useful for exploring ideas about how to remedy such disorder, for example by investigating where to intervene in a particular pathway in order to correct the disorder.

WO 02/21420 describes creating and using knowledge patterns, such as a self-organising knowledge map, for recognising previously unseen or unknown patterns from large amounts of pharmaceutical data obtained by virtual screening. However, such an approach can be difficult from a user perspective due to the inherent complexity of the algorithms employed to determine the pattern matching and so on.

US 2002/0187514 describes the use of a two-dimensional table that maps compounds against targets. The table also stores experimental results from screening the compounds against the targets. The table can be used to help predict the potential use of a new compound as a drug, by looking in the database for targets that are known to interact with compounds associated with the new compound.

Computing in genomics and for biochemical modelling can therefore provide a way to accelerate the traditional drug development process. In particular, computers typically enable targets for new drugs to be identified more rapidly.

However, it is not generally appreciated that the large majority (about 90%) of all drugs approved each year can be classed as improvements upon existing drugs. In contrast, completely new drugs, which generally represent the primary focus of conventional drug research, form only a small proportion of marketing approvals. Thus each year the FDA typically approves about 40 drugs and biologics (therapeutics derived from living sources), and the majority of these cover modifications or enhancements of previous approvals.

For example, an existing drug may be approved for use in a different treatment regime, or in combination with certain other drugs, or for treating disorders that are closely related to the disorder for which the drug was originally approved. (Here, a closely related disorder may be regarded as generally sharing the same patho-physiological mechanisms and also covered within the same therapeutic area, e.g. depression and anxiety).

A rather different category of marketing approvals is where a previously approved drug is found to be valuable in a new and different context, such as in a different therapeutic area from the originally approved indication. Research has indicated that such secondary indications of drugs can be highly significant. For example Gellings et al examined the top twenty best selling US blockbuster drugs, and found that 40 percent of the revenues came from sales for secondary indications. (Gellings et al, (1998), New England Journal of Medicine, Volume 339, Number 10, pages 693-698). Moreover, 90 percent of the top twenty blockbusters were reported to have sales for such secondary indications. Similarly, Pritchard et al analysed the top 50 best selling drugs in the UK in 1999, and found that overall only 62 percent of revenues were for the original indication. (Pritchard et al, (2001), “Capturing the Unexpected Benefits of Medical Research”, Office of Health Economics, London). A further 25 percent of sales were for new and unlicensed indications, rather than for the originally launched indication. (The remaining 13 percent of prescriptions were classified as unknown, but many of these may have been for secondary indications as well). About half of the drugs examined in this survey had sales for additional indications.

One particularly well-known example where a secondary indication has proved of great commercial significance is for the drug sildenafil, developed by Pfizer Inc (and marketed under the trademark of Viagra). While this drug was being tested for the treatment of cardiac problems, it was observed that the drug was in fact active against male erectile dysfunction, which has since become the primary market for the drug.

In fact sildenafil was relatively unusual among such discoveries of new drug indications, in that it occurred around the time of the first testing in healthy human volunteers. In contrast, unexpected benefits for known medicines are usually observed after the drug is already on the market, since at this stage a large and heterogeneous patient population with a range of underlying disease is exposed to the new agent.

Another example of the discovery of additional indications is the drug finasteride, developed by Merck & Co Inc (and marketed under the trademarks of Proscar and Propecia). This drug was originally approved for the treatment of benign prostatic hyperplasia in 1992. However, it was subsequently observed that the drug was also useful for the treatment of alopecia. Finasteride was approved for this secondary indication in 1998, and this has since become the primary market for the drug. Further studies, published in 2003, have revealed that finasteride may also be effective against prostate cancer.

Unfortunately, many potential discoveries of additional indications for existing drugs are lost or delayed, due to the huge amount of clinical data that is available once a drug goes onto the market. Much of this data may appear in the medical research literature, but never be returned from the various hospitals and doctors in the field to the pharmaceutical company responsible for the drug. Furthermore, even if a particular side effect is observed and reported to the relevant pharmaceutical company, the team working on a particular drug is normally specialised in the therapeutic area for which the drug was originally targeted. This team is likely to regard the side effect as a problem in the use of the drug for its primary indication, and is unlikely to appreciate that the same side effect may in fact have potential benefit in a completely different therapeutic area.

Consequently, although the discovery of new indications for existing drugs has been of considerable commercial significance, the pharmaceutical industry has generally concentrated instead on the traditional development of new drugs using a conventional scientific approach. The discovery of new indications for existing drugs has largely been left to serendipity.

Moreover, even in circumstances where the potential value of searching for secondary indications of existing drugs has been appreciated, see for example the article on therapeutic switching at www.arachnova.com, the implementation of such searches remains difficult. For example, the sheer volume of information available from clinical and biomedical literature databases, combined with the heterogeneous origins and terminology of such literature, represent formidable obstacles to the use of such databases for the identification of possible secondary indications.

### SUMMARY OF THE INVENTION

Accordingly, one embodiment of the invention provides a method of computer-assisted pharmaceutical investigation using a pharmaceutical knowledge base containing multiple information items. Typically the pharmaceutical knowledge base is stored in one or more computers. The method involves providing at least three axes representing pharmaceutical knowledge in a multi-dimensional coordinate space, in which a first axis pertains to disease, a second axis pertains to targets, and a third axis pertains to drug compounds. Pharmaceutical knowledge is mapped into the multi-dimensional coordinate space by assigning an information item to one or more locations in the coordinate space, dependent upon the data contained within the information item.

Such an approach can be used to integrate various and diverse sources of textual, numerical, and graphical data to assist in identifying drugs and indications. A resulting analysis supports the systematic identification of potential indications and other medical utilities for drugs and drug targets, in contrast to earlier reliance on chance and serendipity.

In one embodiment, each axis is defined by multiple entities along the axis. Thus each entity on the first axis is a disease, each entity on the second axis is a target, and each entity on the third axis is a compound. A unique identifier is allocated to each entity. This addresses the frequent situation that a single entity has multiple names, for example, tuberculosis might also be referred to as TB, as consumption, as phthisis, or as Mycobacterium infection. The use of the unique identifier therefore helps to prevent the same underlying entity from appearing multiple times on the same axis.

In one embodiment, one or more ancillary parameters are provided for at least some of the multiple entities. The ancillary parameters can be used to describe properties of the entity concerned. One possibility is to provide a set of synonyms for the entity, which again helps to address the widespread variations in terminology. In other words, if an entity is allocated the name of tuberculosis, then TB, consumption, phthisis, and Mycobacterium infection might all be listed as synonyms. The use of such synonyms allows all information items that relate to tuberculosis to be identified, irrespective of how they refer to the disease.

Another potential ancillary parameter may be used to map from a first entity on one axis to a second entity on another axis. For example, a compound (drug) entity may store the names of diseases that the drug is used to treat. Such information is typically available from industry databases, e.g. of available drugs. The approach described herein is primarily intended to go beyond such known mappings, and to uncover associations that have not hitherto been generally recognised (even if they may have been suggested somewhere in the literature).

Thus an information item (typically a research paper or such-like) is assigned a location in the multi-dimensional coordinate space by identifying a link between the information item and two or more entities. The position of the linked entities on their associated axes determines the location of the information item in the coordinate space. Turning this around, the existence of the information item can be regarded as providing evidence of some linkage between the entities concerned.

In one embodiment, an information item is linked to an entity by performing a textual search of the information item for the name of the entity. Typically the information items represent entries in a literature database of pharmaceutical, biological and medical research papers. The information items may incorporate the whole text of the papers, or perhaps just their abstracts, potentially with other bibliographic details.

As previously indicated, there is frequently a range of terminology that can be used with any given entity, as represented by the set of synonyms for the entity. Accordingly, in one embodiment, an information item may also be linked to an entity by performing a textual search of the information items for the synonyms (as well as the name) associated with the entity. The use of synonyms in this manner is found to significantly enhance the power of the approach described herein.

Another embodiment of the invention provides a method of computer-assisted pharmaceutical investigation using a pharmaceutical knowledge base containing multiple information items. A computer system can be used to store a first set of named entities corresponding to one axis and a second set of named entities corresponding to another axis. The axes are selected from a disease axis, a target axis, and a drug compound axis. Each entity incorporates a set of synonyms for the entity name. The information items can then be searched for any linkage between a specified entity on a first axis and each of the set of entities on a second axis, where a linkage is potentially indicative of a pharmaceutical connection between the entities concerned.

Typically, a linkage is found between a first entity and a second entity if both the first and second entities are related to a single information item. In one embodiment, an entity is related to an information item if the name or any synonym of the entity is present in the information item. In other embodiments, more sophisticated tests of linkage might be employed, for example based on semantic analysis, that might be used to assign a confidence or relevance to the linkage.

In one embodiment, the output from the searching is presented as a (text-based) listing of the entities on the second axis. The listing may omit entities on the second axis that do not have any linkage to the specified entity of the first axis, in other words, those entities for which no connecting information items were located. Typically, the entities on the second axis are ordered in the listing according to the number of information items for which there is a linkage between the specified entity and the entity on the second axis. Thus if there are many information items linking an entity on the second axis to the specified entity on the first axis, this is suggestive of a strong connection, and so may be presented near the top of the listing.

As previously indicated, certain associations between the axes may already be known, and recorded in information associated with one or more of the relevant entities. In one embodiment therefore, the listing may omit entities from the second axis that have such a recognised linkage to the specified entity of the first axis. This helps the user to focus on any linkages that have not hitherto been appreciated, and which are therefore of potentially the greatest interest.

Generating search results for each entity on the second axis is often a computationally intensive task. In one embodiment therefore, the search results are (pre)computed on a periodic basis, and then stored for subsequent retrieval in response to particular user requests. Since it is not known in advance which entity on the first axis the user will specify, this generally involves precomputing and storing listings for every entity on the first axis (or at least, precomputing and storing some form of data structure(s) from which the relevant listings can be recreated).

Typically the first axis is different from the second axis. For example, the listing might represent linkages between a compound entity on the first axis, and disease entities on the second axis. However, the same approach may be used even where the first and second axes both relate to the same property—e.g. both are disease axes, or both are compound axes. Finding linkages between the same form of axes may be pharmaceutically useful, for example to understand co-occurrences of diseases.

In one particular embodiment, a third set of named entities is provided. The first set, second set and third set of entities correspond to different ones of a disease axis, a target axis, and a drug compound axis. These three axes then define a space that can accommodate all relevant pharmaceutical knowledge.

In order to improve the power of the system, it is possible for the set of entities for at least one axis to be substantially comprehensive for pharmaceutical knowledge relating to that axis. For example, the entities on the disease axis may incorporate substantially all known diseases, while the set of entities for the drug compound axis may be substantially comprehensive for compounds currently marketed or under public development as drugs.

Another embodiment of the invention provides a method of computer-assisted pharmaceutical investigation. The method includes specifying a candidate hypothesis of the generic formula “A is related to B”, where A is selected from a first axis, and B is selected from a second axis. Queries are then generated for investigating the candidate hypothesis in a systematic and comprehensive manner with respect to each possible value of B along the second axis. These queries can then be used for searching a pharmaceutical knowledge base containing multiple information items for evidence in support of the candidate hypothesis for each possible value of B along the second axis.

The above approach can be used for investigating a very wide range of hypotheses including the identification of:

(a) compounds B that may be useful medicaments for the treatment of a disease A.

(b) targets B that may be useful for the treatment of a disease A.

(c) further disease indications B for a compound A that is known to be active against at least one other disease indication.

(d) further disease indications B for a target A that is known to be relevant to at least one other disease indication.

(e) compounds B that may be useful biomarkers or diagnostics for a disease A.

(f) compounds B that are known to have no effect in relation to a disease A.

(g) compounds B that have an adverse effect in relation to a disease A.

(h) compounds B that have an interaction with a compound A for determining drug-drug synergies.

(i) compounds B that have an interaction with a compound A for determining drug-drug adverse effects.

(j) compounds B that have an interaction with a target A.

(k) targets B with which a compound A has an interaction.

(l) diseases B that have a co-occurrence relationship with a disease A.

In one embodiment the first axis corresponds to disease, target or compound, and the second axis corresponds to disease target or compound. Other embodiments may support additional possibilities for the first and second axes, such as anatomy, tissue type, cell type, experimental procedure and so on. The second axis may the same as or different from the first axis.

In order to permit a complete and systematic analysis, the axes themselves can be set up to be substantially comprehensive. For example, the disease axis may be derived from one or more dictionaries or encyclopaedias of diseases. The compound axis may be derived from databases of drugs that are being marketed or that have been disclosed as under development. Although such databases are not comprehensive for all possible compounds, they do include all known marketed, experimental and prototype drugs, and so allow a complete search for secondary indications to be made. The target axis may be derived from the list of genes and protein products expressed from one or more genomes. In another embodiment the target axis is derived from targets that are known to interact with compounds on the compound axis. Although this is less complete than deriving the target axis from an entire genome, it helps to focus on targets that are known to be susceptible to drug action (these will be referred to herein as having good druggability). Such targets may correspond to a relatively small proportion of the entire genome.

An axis based on anatomy, cell type, tissue type, and so on can likewise be set up based on information from biological encyclopaedias and other appropriate reference sources. Note that the number of entities on such an axis may be significantly less than the number of entities on an axis such as disease or compound. For example, there may only be hundreds of different cell types defined as entities on an entity axis, whereas there may be thousands of different diseases defined as entities for a disease axis.

Various filters may be applied to the axes and/or search results, in order to improve their usefulness. For example, if the second axis represents target, the values of B along the second axis might be filtered to exclude those targets for which no drug compound has been launched. This therefore concentrates investigations onto targets that are known to have some marketed drug available. Another possibility is that values along the target axis are filtered to exclude those targets having poor druggability.

The search results are generally presented as an ordered listing of the values of B for which the generated queries provided evidence in support of the candidate hypothesis. Usually, the listing is ordered according to the number of information items that support the candidate hypothesis, this being some indication of the amount of evidence to back up the relevant hypothesis. Results may also be ranked (and/or filtered) using semantic algorithms, which typically generate and rank correlations between terms.

Another possibility is that the listing is ordered according to confidence in the candidate hypothesis. This reflects the fact that various information items may provide different amounts of support for a particular hypothesis. One way of assessing such confidence is to perform some form of semantic processing on the information items, rather than simply scanning for the presence of particular text strings.

It is also possible to order the results in accordance with some ontology relevant to the second axis itself, rather than strength of support for the candidate hypothesis. One advantage of this approach is that spatial relationships in the listings may then have physical implications. For example, if the target axis is ordered in accordance with some protein property, and many links are found between a disease and targets that have a similar set of protein properties, this will then appear as a cluster in the listing, which may have pharmaceutical significance. It will be appreciated that such clustering can be detected by visual inspection of suitable graphical plots of the data, or by using appropriate statistical techniques.

More broadly, a wide range of triaging, filtering, ranking, clustering and sorting methods may be employed with respect to investigations of the information items and/or the output listings from the queries. Such investigations may also employ text-mining, semantic algorithms, statistical pattern matching, network analysis, heuristic algorithms, neural network algorithms, and so on.

Another embodiment of the invention provides a method of determining a drug for the treatment of a disease by identifying the drug as a potential treatment for a disease using the approach described above, and then confirming by experiment that the drug can be used as a treatment for said disease. If the confirmation is successful, then the drug can proceed through development and testing to manufacture.

The approach described herein therefore supports computer-assisted drug or indications discovery based on the systematic and comprehensive calculation of potential scientific hypotheses relevant to drug investigations, and in particular involving compounds, targets and diseases. Various data sources may be searched for evidence to support the generated hypotheses. The data sources may be provided by a single, combined or federated database of information (for example the MEDLINE collection of biomedical literature), by single entry additions, by feeds of non-database information, such as news-wires, by proprietary documents or results, (e.g. internal company reports) and so on. It will be appreciated that two or more such data sources can be combined as appropriate.

Compounds that may be useful medicaments for the treatment of a disease may be identified by the systematic analysis of known compounds (as defined in databases such as the British National Formulary, the Investigational Drugs Database, or a proprietary database of biologically modulating agents). Likewise, targets that may be useful in identifying medicaments for the treatment of a disease may be identified by the systematic analysis of known targets. Potential targets include all the gene and protein products expressed from an organism's genome, gene transcript products such as RNA, and DNA itself in order to modulate gene expression or function. Such analysis is greatly enhanced by using synonyms of the compounds or targets concerned. Similarly, disease, indications and medical utilities for a known compound or target which may lead to a useful medicament for the treatment of another disease may be identified by the systematic analysis of known diseases, indications and their synonyms (as defined in databases such as The International Statistical Classification of Diseases and Related Health Problems). The systematic analysis is performed against a literature database and/or other set(s) of data sources.

Similar forms of analysis can also be used to identify new combinations of medicaments for therapeutic purposes, and also to identify new biomarkers and surrogate markers (whether biochemical, metabolic, protein, genetic, physiological, phenotypic or technological) to aid drug discovery, clinical diagnostics and/or patient profiling to identified indication(s). The analysis can also be directed towards questions of toxicity, adverse effects, or other drug safety data, to aid in the development of medicaments for therapeutic purposes, and/or towards finding drug-drug interactions for identifying adverse effects or undiscovered synergies for the development of medicaments for therapeutic purposes. Another possibility is to investigate questions relating to drug absorption, excretion, metabolism, and/or transportion properties. In addition, disease co-occurrences and epidemiological hypotheses can be identified and explored.

Such analysis can therefore be regarded from one perspective as a form of virtual throughput screening, for example to identify medicaments for therapeutic purposes, or to identify targets that bind existing medicaments, drugs or biologically active compounds. Such screening can be used to systematically and comprehensively calculate all potential scientific hypotheses relevant to drug discovery and to search various data sources for evidence to support the generated hypotheses. The comprehensive nature of such screening is feasible since the total number of drug discovery hypotheses is limited by number of known genes found in the human genome (for example the ˜25000 protein expression genes in the human genome), although this is also expandable to include the genomes of known pathogenic organisms, such as viruses and bacteria, and the total number of recognised human diseases (for example those listed in disease dictionaries). Note however that even where such screening does lead to possible or suggested drugs or targets, in many circumstances there may still be a considerable amount of effort and ingenuity required in the laboratory in order to confirm and exploit the results of the virtual screening.

A systematic, computerised analysis of various data sources may also assist with the development of ontologies and classification systems for diseases, indications, proteins, drug targets, medicaments and so on. In particular, clustering, semantic correlation, and other statistical techniques can be used to analyse various ontologies, and to determine those that are particularly valuable for pharmaceutical investigations by revealing unanticipated connections in the data sources.

In order to allow searching to be performed on the basis of structural similarity (rather than chemical name), for example using the Tanimoto method of similarity, knowledge of chemical structure, such as derived from databases, dictionaries, and/or modelling programs, can be associated, linked or embedded into the system. Likewise the system can be provided with a knowledge of target structure, for example based on or derived from gene sequence, in order to allow searching on the basis of target structure (for example using protein structure similarity algorithms such as threading, Dali, or Papia). In some embodiments, the search engine or database may natively support searching by structural similarity. In other embodiments, a tool may be used to derive the names of chemicals (or targets) having a structural similarity, with these names then being used as synonyms during the search.

The above approach for pharmaceutical investigations may be implemented in the form of a method, a system, a computer program and/or a computer program product. It will be appreciated that these various forms will all generally benefit from the same particular features described herein. Note that program instructions for implementing the invention are typically provided on some fixed, non-volatile storage such as a hard disk or flash memory, and loaded for use into random access memory (RAM) for execution by a system processor. Rather than being stored on the hard disk or other fixed device, part or all of the program instructions may also be stored on a removable storage medium, such as an optical (CD ROM, DVD, etc), magnetic (floppy disk, tape, etc), or semiconductor (removable flash memory) device. Alternatively, the program instructions may be downloaded via a transmission signal medium over a network, for example, a local area network (LAN), the Internet, and so on. Data for manipulation by the program instructions may be provided with the program instructions themselves, and/or may be provided from additional source(s).

### BRIEF DESCRIPTION OF THE DRAWINGS

Various embodiments of the invention will now be described in detail, by way of example only, with reference to the following drawings, in which like reference numerals pertain to like elements, and in which:

FIG. 1 depicts a schematic three-dimensional space for representing pharmaceutical knowledge;

FIG. 2 represents a two-dimensional slice through the three-dimensional space of FIG. 1;

FIG. 2A represents a two-dimensional slice through the three-dimensional space of FIG. 1, but with the same parameter plotted on both axes;

FIG. 3 depicts a drug identification procedure in the three-dimensional space of FIG. 1;

FIGS. 4A and 4B illustrate two stages of a traditional drug identification approach to implement the procedure of FIG. 3;

FIGS. 5A and 5B illustrate two stages of a drug identification method in accordance with one embodiment of the present invention; and

FIG. 6 depicts a drug identification method in accordance with an alternative embodiment of the present invention.

FIG. 7 is a schematic view of a computer system architecture in accordance with one embodiment of the invention for assisting in drug identification;

FIG. 7A is a schematic view of a computer system architecture in accordance with an alternative embodiment of the invention for assisting in drug identification;

FIGS. 8, 9, and 10 are screens illustrating the data held for each of the three axes (namely disease, target and compound respectively) utilised in the model of FIG. 1;

FIG. 11 illustrates the top-level user interface screen of the system of FIG. 7, as configured for searching by disease;

FIG. 12 illustrates the result of searching for the disease specified in FIG. 11;

FIG. 13 depicts the result of searching information items in a text database for the disease mentioned in FIG. 12 against a range of targets;

FIG. 14 presents a subset of the search results of FIG. 13, limited to targets that have a launched drug that interacts with the target;

FIG. 14A represents the view of FIG. 14, scrolled down slightly;

FIG. 15 presents a listing of information items corresponding to one of the lines of search results in FIG. 14;

FIG. 16 illustrates the abstract of one of the information items in the listing of FIG. 15;

FIG. 17 illustrates the top-level user interface screen of the system of FIG. 7, this time as configured for searching by target (in contrast to FIG. 11);

FIG. 18 illustrates the result of searching for the target specified in FIG. 17;

FIG. 19 depicts the result of searching information items in a text database for the target mentioned in FIG. 17 against a range of diseases;

FIG. 19A represents the view of FIG. 19, scrolled down slightly;

FIG. 20 presents a listing of information items corresponding to one of the lines of search results from the listing of FIG. 19;

FIG. 21 presents an analogous view to that of FIG. 19, but for a different target;

FIG. 22 presents a listing of information items corresponding to one of the lines of search results from the listing of FIG. 21;

FIG. 23 illustrates the abstract of one of the information items in the listing of FIG. 22; and

FIG. 24 is a flowchart illustrating the precomputation of queries in accordance with one embodiment of the invention.

### DETAILED DESCRIPTION

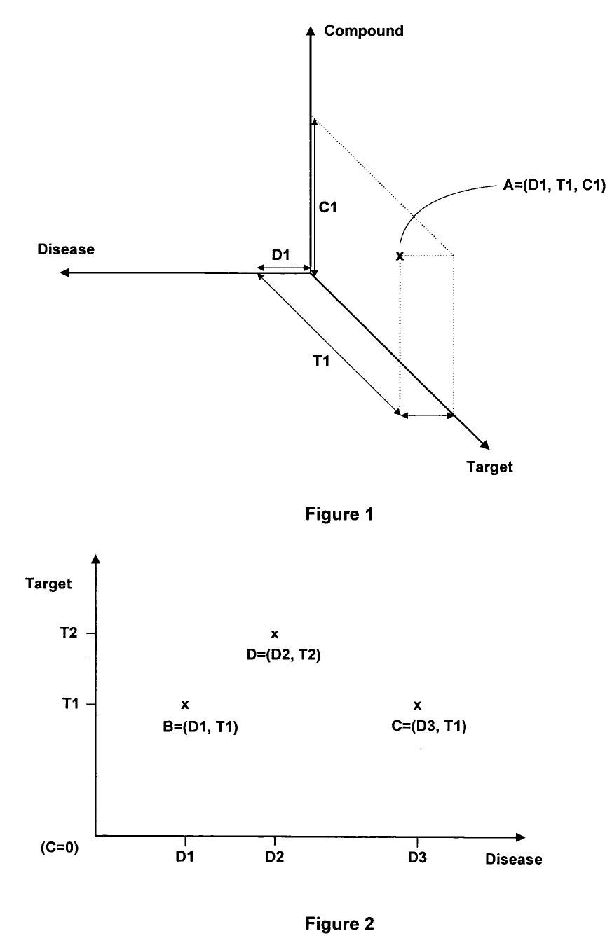

FIG. 1 illustrates a three dimensional co-ordinate space in which a first axis represents disease (D), a second axis represents target (T), and a third axis represents compound or drug (C). In this context, a disease can be viewed as any deleterious or unwanted condition, symptom or indication affecting a patient (be that human or animal in the veterinary context), in which the outcome of that condition may be able to be modulated by some known or hypothetical agent against a specific target. A target (or drug target) may be viewed as any biological entity (protein, peptide, poly-nucleotide, carbohydrate or other biological material), the function or activity of which can be modulated through the use of a naturally occurring or artificially synthesised agent (chemical compound, peptide, antibody, protein or similar). A compound, as used herein, may be any agent which can potentially modulate the function of a particular target as a treatment for one or more diseases. Compounds may therefore include agents such as small molecules, anti-bodies, peptides, proteins, poly-nucleotides and other target modulatory entities. It will be appreciated that in some circumstances, a particular substance might be represented on both the target and the compound axes.

Knowledge for pharmaceutical drug discovery purposes can be located as appropriate within the three-axis space of disease, target and compound shown in FIG. 1, which in one current implementation is referred to as a pharmacological matrix, shortened to “Pharmamatrix”. Information items from various sources relevant to drug discovery (e.g. research papers, internal company reports, books, clinical trial results, regulatory filings, etc.) can be positioned within this pharmacological matrix.

In particular, FIG. 1 illustrates one such information item plotted within the matrix. Thus point A, corresponding to one particular information item, is shown at the intersection of Disease=D1, Target=T1, and Compound=C1. This indicates that the information item represented by point A mentions or pertains to disease D1, target T1, and compound C1. We can therefore regard point A as being defined by the vector (D1, T1, C1).

The presence of point A may of course suggest that compound C1 is useful for treating disease D1 by acting upon target T1. Alternatively, there may be other reasons for the linkage shown, such as that compound C1 in acting upon target T1 is known to cause disease D1 (this will be discussed in more detail below). Note that any given information item may define multiple vectors in the matrix, for example, an information item may discuss the use of a range of compounds against a particular target.

Each vector in the matrix of FIG. 1 can be written as:
[D, dx, dy, dz . . . ; T, tx, ty, tz . . . ; C, cx, cy, cz . . . ]
Here, D, T and C represent the disease, target and compound identifiers respectively, while dx, dy, and dz represent additional parameters associated with the disease; tx, ty, and tz represent additional parameters associated with the target; and cx, cy, cz represent additional parameters associated with the compound or drug. We will refer herein to D, T and C as the primary parameters, since they define the three axes of the matrix, and additional parameters such as dx, tx, and cx as ancillary parameters. As just indicated, for any given information item, one or more of the primary and/or ancillary parameters may be missing.

The ancillary parameters associated with a disease might include clinical information such as therapeutic area, epidemiological data, such as number of sufferers, and so on. The ancillary parameters associated with a target might include genetic information, such as known polymorphisms, chemical information, such as crystallography data, and so on. The ancillary parameters associated with a compound or drug might include chemical information, such as formula, physical properties (molecular weight, melting point, etc), medical information, such as toxicological studies, business information such as current marketplace status (approved, in phase 2 trials, etc), as well as ownership of patent rights, and so on.

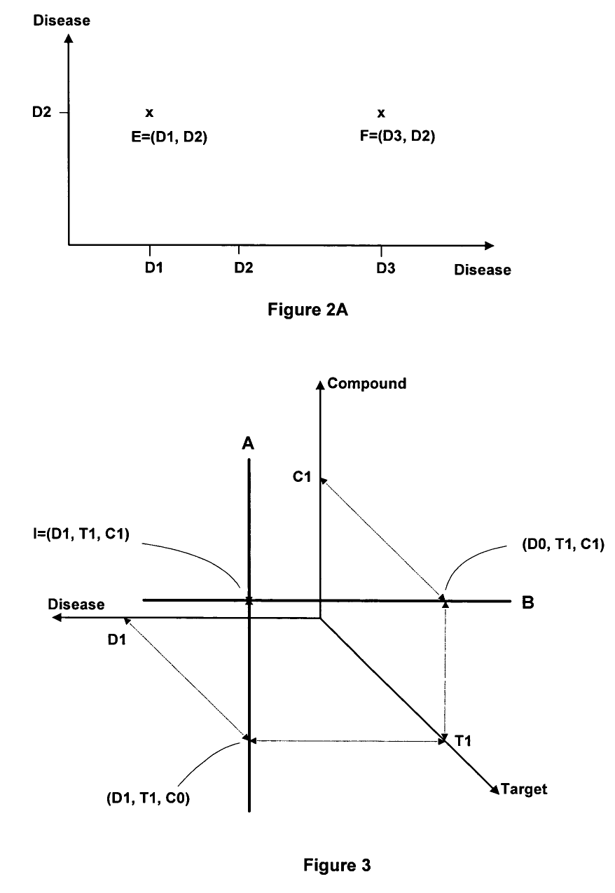

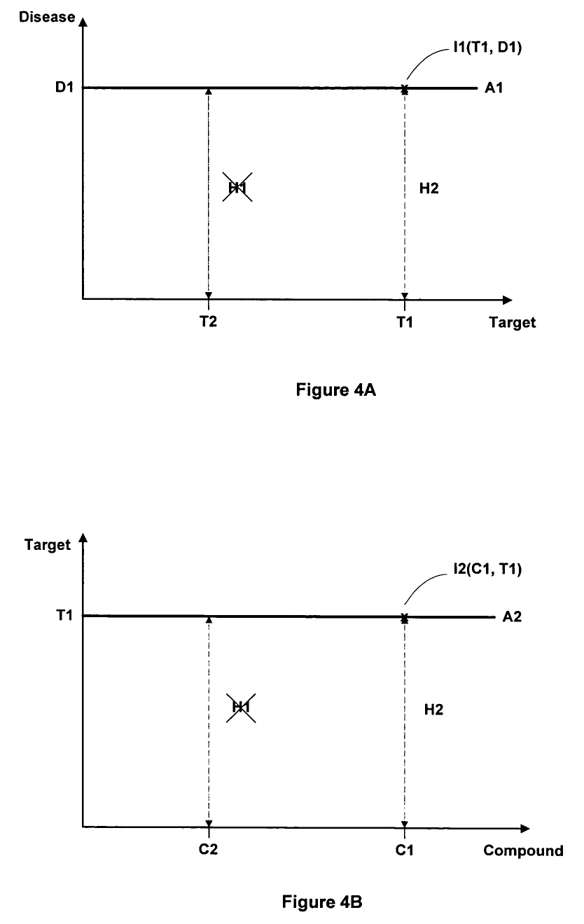

Many information items may contain parameter values for only two of the axes in the matrix. The vectors representing such items can then be located on a plane passing through the origin and normal to the axis corresponding to the missing data item. As an example, FIG. 2 denotes the plane in the matrix defined by the target and disease axes. The plane of FIG. 2 can therefore be used for plotting information items that contain a link or association between disease and target, but do not provide any compound information—i.e. vectors of the form: [D=x, T=y, C=0].

FIG. 2 shows two vectors (corresponding to points B and C) that relate to the same target (T1) but to different diseases (D1 and D3). A third vector, denoted as point D in FIG. 2, represents a linkage between another target (T2) and another disease (D2). For all vectors B, C and D in FIG. 2, the value of the compound coordinate is set to zero or null, thereby indicating the absence of compound information.

One special form of two-dimensional diagram is where the same parameter is plotted on both axes. This is illustrated in FIG. 2A, where both the ordinate and the abscissa represent disease. Information items that mention more than one disease can then be located as appropriate on this diagram. For example, point D corresponds to an information item that mentions both disease D1 and also disease D2, while point E corresponds to an information that mentions both disease D1 and also D3. The use of plots such as shown in FIG. 2A will be discussed in more detail below.

It will be appreciated that in general there is no intrinsic ordering of the different axes (e.g. there is no inherent linear scale of disease). The axes can therefore be constructed in some quasi-arbitrary fashion, for example by alphabetic (or numerical) ordering of a unique identifier for the primary parameters of the respective axes. Alternatively, the ancillary parameters may be used to determine the ordering of one or more axes, such as by defining the location of the relevant primary parameter(s) on the corresponding axes. Thus the disease axis may be ordered in terms of clinical area, so that cardiovascular disorders (for example) are clustered together on the disease axis.

The benefit of ordering the different axes depends in part on how the matrix is being used. Thus if the main objective is to discover point intersections (as described in more detail below), then such activities are relatively independent of the ordering of the axes. On the other hand, there may be circumstances where the spatial relationships between different vectors in the matrix are potentially valuable. For example, it may be known that certain compounds are effective against a particular target, but that precise details of the interaction are poorly understood. If the compound axis is plotted in terms of some physical property (e.g. pH) that leads to the interacting compounds being clustered together, then this may give some insight into the underlying biochemistry. In other words, the ancillary parameters can be used to establish various classification schemes or ontologies for the different axes, and these can then be used to organise and hence further investigate the information items.

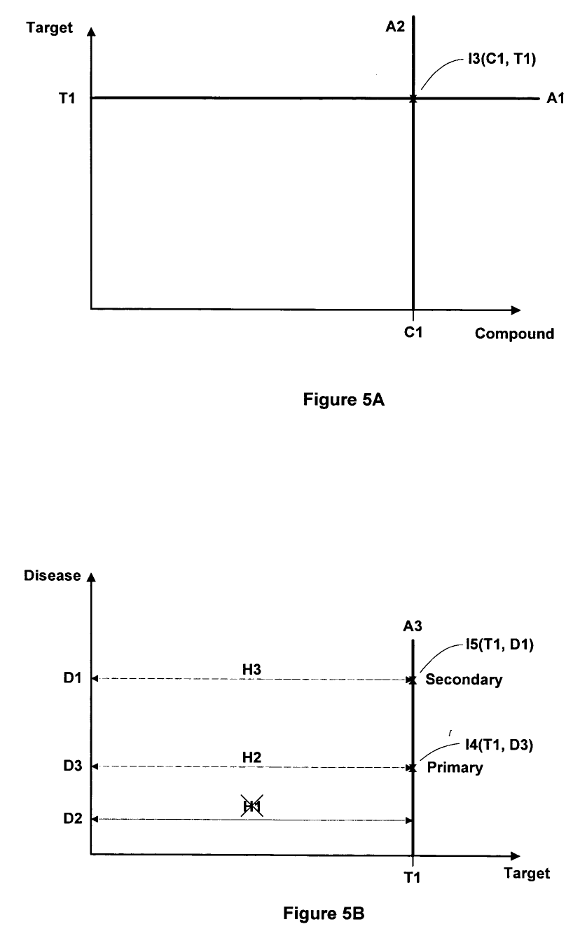

FIG. 3 illustrates in schematic form a typical drug discovery as depicted in matrix of FIG. 1. Thus starting with the discovery or recognition of a disease (D1), a target (T1) is identified that is relevant to this disease. The combination of D1 and T1 defines a line in the matrix, illustrated in FIG. 3 by line A. This line runs parallel to the compound axis and passes through the coordinate (D1, T1, C=0). Next, a drug or compound (C1) is found that interacts with the target T1. This defines a second line in the matrix, represented in FIG. 3 by line B. This second line runs parallel to the disease axis, and passes through the coordinate (D=0, T1, C1). The intersection of lines A and B, corresponding to the vector I=(D1, T1, C1), then identifies the possibility of using compound C1 as a drug for treating disease D1 by interacting with target T1.

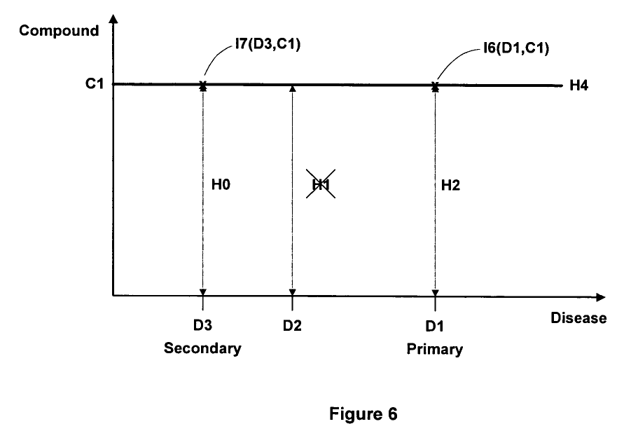

FIGS. 4A and 4B illustrate such a (traditional) drug discovery process in more detail, as successive activities within two different planes of Pharmamatrix. FIG. 4A depicts a plane defined by the disease (D) and target (T) axes. Once a particular disease (D1) has been identified, it can be represented by the line A1 in the plane shown in FIG. 4A, which runs parallel to the target axis and passes through (D1, T=0).

Subsequently, we assume that scientific research into the disease discovers one or more targets that are potentially relevant to the disease. Each such target can be defined by a line in the plane of FIG. 4A parallel to the disease axis. Two such target lines are shown in FIG. 4A, namely line H1 corresponding to target T2, and line H2 corresponding to target T1. It is assumed that research shows that target T1 is relevant to disease D1, but target T2 is not relevant to disease D1. Accordingly, we can ignore line H1, and define a positive result at the intersection of lines A1 and H2 in FIG. 4A. This is shown in FIG. 4A as intersection I1, corresponding to the vector (D1, T1, C=0). Once point I1 has been identified, this allows us, in effect, to draw line A in FIG. 3, as running parallel to the compound axis, and through the point defined by vector I1.

FIG. 4B now illustrates how line B from FIG. 3 is determined. Thus FIG. 4B depicts the plane defined by the target (T) and compound (C) axes. Note that from the research shown in FIG. 4A, we already know that a (or the) target of interest is T1. This allows us to define line A2 in FIG. 4B, which runs parallel to the compound axis and passes through the point (T1, C=0).

Further research may now be performed, this time in order to discover a compound that is effective against the target (T1), which is known to be relevant to the disease of interest (i.e. D1). Each candidate compound can be defined by a line in the plane of FIG. 4B parallel to the target axis. Two such compound lines are shown in FIG. 4B, namely line H1 corresponding to the compound C2, and line H2 corresponding to the compound C1. It is assumed that research shows that compound C1 interacts with target T1, but that compound C2 does not interact with target T1. Accordingly, we can ignore line H1, and define a positive result at the intersection of lines A2 and H2 in FIG. 4B. This is shown in FIG. 4B as intersection I2, corresponding to the vector (D=0, T1, C1). Once point 12 has been identified, this now allows us to draw line B in FIG. 3, as running parallel to the compound axis, and through the point defined by vector I2.

Having formed both lines A and B in FIG. 3, their intersection I=(D1, T1, C1) is now fixed in the matrix. This intersection is indicative of the fact that compound C1 has potential to treat disease D1 via target T1.

As previously discussed, the activities of both FIGS. 4A and 4B typically represent expensive and time-consuming research efforts. However, the use of the pharmacological matrix allows a radically different drug discovery procedure to be adopted. This new procedure can help to provide accelerated drug discovery at reduced cost.

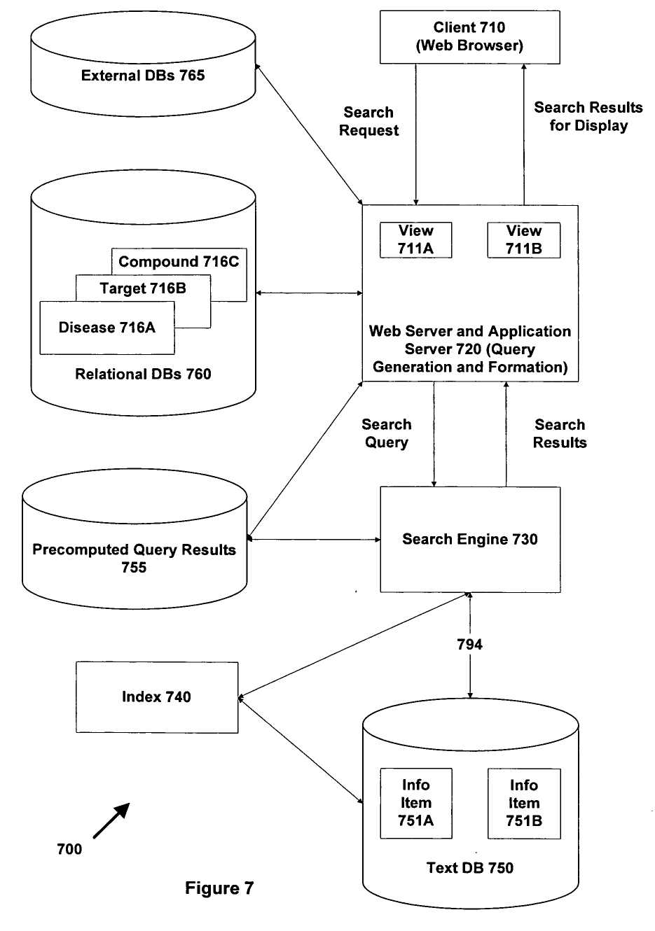

One aspect of the new drug discovery strategy is schematically illustrated in FIGS. 5A and 5B. Looking first at FIG. 5A, this represents the target/compound plane of the matrix. In particular, FIG. 5A depicts a target T1, which allows us to define a corresponding line A1, and a compound C1, which allows us to define a corresponding line A2. The intersection of lines A1 and A2 is represented in FIG. 5A by vector I3=(T1, C1). Note that the discovery of the relationship between target T1 and compound C1 (as denoted by vector I3) may be the result of new research. However, more frequently, this relationship may be known already, based on previous research, typically in relation to a drug compound that is already on the market or undergoing pre-market testing. In other words, the biochemical research that vector I3 represents will frequently have been performed already. Note that knowledge of point I3 allows us to draw line B in FIG. 3 (parallel to the disease axis and through point I3).

Proceeding to FIG. 5B, this illustrates the disease/target plane of the matrix. The objective now is to find diseases or disorders for which target T1 is relevant. Target T1 is represented in FIG. 5B by line A3. Also depicted in FIG. 5B are three diseases, D1, D2, D3, corresponding to lines H3, H1, and H2 respectively. We assume that target T1 is not relevant to disease D2, and accordingly we can ignore line H1, while target T1 is found to be relevant both to disease D1 and also to disease D3. Accordingly, we have a first intersection between line A3 and line H2 at point I4=(D3, T1), and a second intersection between line A3 and line H3 at point I5=(D1, T1).

Considering the intersection of D1 and T1 at point I5, this allows us to define line A in FIG. 3 as the line parallel to the compound axis that passes through point I5. We can then determine the intersection of line B (as plotted from FIG. 5A) with line A (as just plotted from FIG. 5B), in order to locate point I=D1, T1, C1. Similarly, point I4 can be used to define another intersection with line B in the matrix, this time corresponding to vector (D3, T1, C1).

The plots of FIGS. 5A and 5B provide a method to discover possible secondary indications for a drug. Assume, for example, that drug C1 is already known for treating disease D3 via target T1. This then defines the location of point I3 as the intersection of compound C1 and target T1, without the need for further biochemical research. Given this existing use of C1, we expect to see at least one intersection in FIG. 5B, namely point I4, since this intersection represents the already known indication of compound C1 for treating disease D3. (This is therefore marked as the primary indication in FIG. 5B). However, using the matrix allows us to look for further intersections, such as I5, that indicate other diseases where target T1 is thought to play a role, so that such diseases might also be potentially treatable with compound C1. Thus in FIG. 5B, line H2 depicts a connection between disease D1 and target T1. This therefore suggests a possible secondary indication for compound C1 in treating disease D1 via target T1.

It will be appreciated that in some respects the drug discovery procedure of FIGS. 5A and 5B may be considered as the reverse of the procedure of FIGS. 4A and 4B. Thus in FIGS. 5A and 5B we first determine line B from FIG. 3, and then line A, whereas in FIGS. 4A and 4B we determine line A first, and then line B. This reversal of the conventional drug discovery procedure has particular relevance for developing a systematic approach to locating secondary indications of existing drugs, which has previously been largely the realm of serendipity—i.e. no systematic approach has been available or employed in the industry.

Note also that the research and development effort associated with the procedure of FIGS. 5A and 5B is significantly reduced in comparison with the traditional procedures of FIGS. 4A and 4B. Thus in FIG. 5A we exploit an existing piece of knowledge, namely that compound C1 is already used to treat D1 via target T1. This provides a saving in time and research expenditure compared to the analysis required for the corresponding portion of a traditional drug discovery programme (as illustrated in FIG. 4B). Furthermore, if C1 is already on the market for treating an existing disorder, then much of the testing necessary to bring a drug to market has already been performed (e.g. toxicology testing, etc.).

It should also be noted that investigations of targets and diseases (such as depicted in FIG. 5B) are frequently carried out as medical (rather than pharmaceutical) research. In this case, a frequent problem faced by pharmaceutical researchers is simply coping with the sheer volume of information available from external sources (hospitals, medical researchers, etc). The use of the pharmacological matrix alleviates this problem, by providing a facility for researchers to analyse quickly and systematically all available medical and pharmaceutical data.

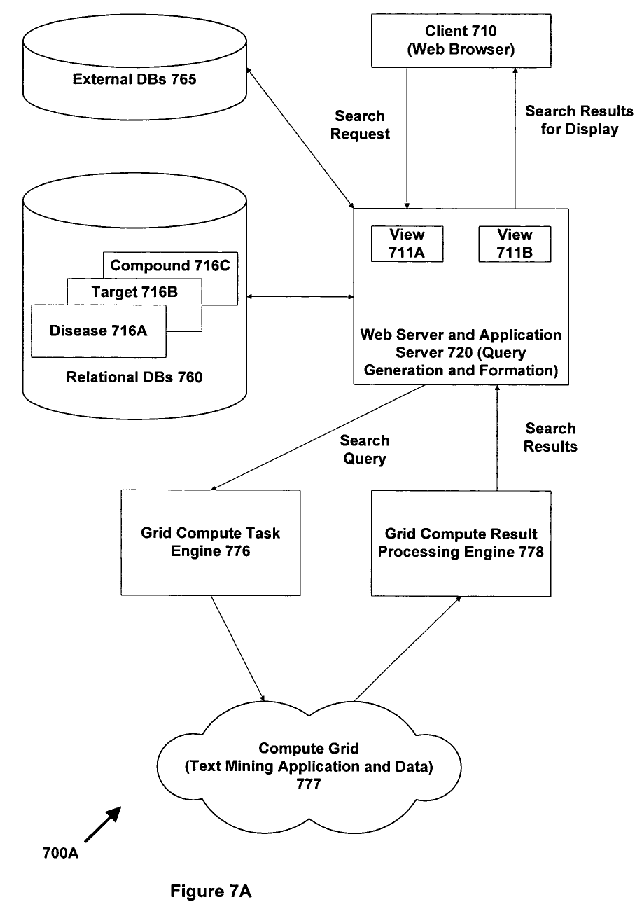

FIG. 6 depicts a drug discovery procedure in accordance with an alternative embodiment of the invention. In this embodiment activity is largely confined to the compound/disease plane (note that this plane is not really involved at all in the conventional drug discovery process, such as illustrated in FIGS. 4A and 4B). Thus in FIG. 6, an existing drug C1, represented by line H4, is known for treating disease D1, as indicated by line H2. Accordingly, a vector I6 has been located at the intersection of lines H2 and H4, representing the primary indication for drug C1. However, we are also interested in what other diseases might possibly be treated using compound C1 (irrespective of whether or not such treatment would utilise the same target T1 as the interaction between compound C1 and disease D1).

FIG. 6 shows one disease, D2, corresponding to line H1, for which there is no interaction with compound C1. Hence no intersection is plotted. On the other hand, disease D3, as represented by line H0, is indeed found to be linked to compound C1, as indicated by the intersection I7=(C1, D3). Accordingly, FIG. 6 reveals a secondary indication of compound C1 for treating disease D3.

It will be appreciated that although the knowledge underlying intersection I7 may in fact already be available in the public domain, the huge volume of medical literature renders the chances of discovering intersection I7 by serendipity alone very slim. In contrast, the use of the pharmacological matrix permits such discoveries to be sought in a systematic and structured manner.

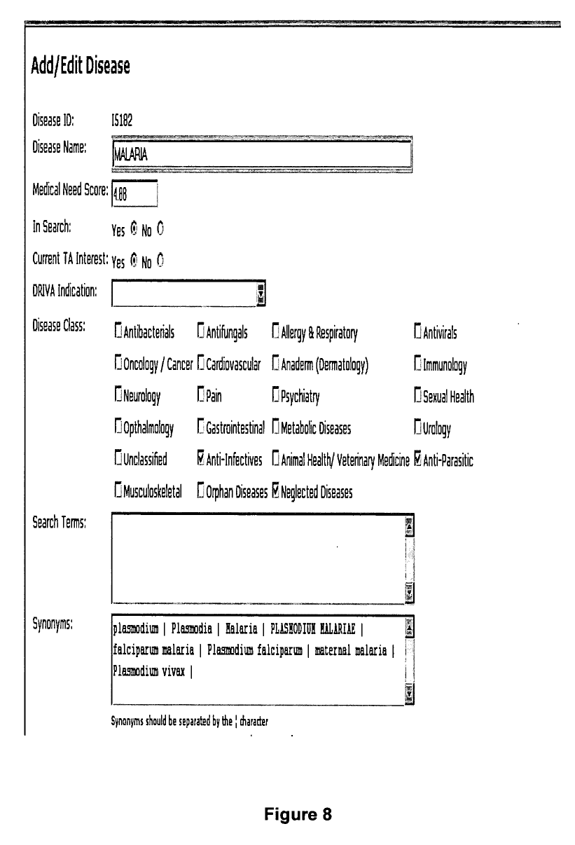

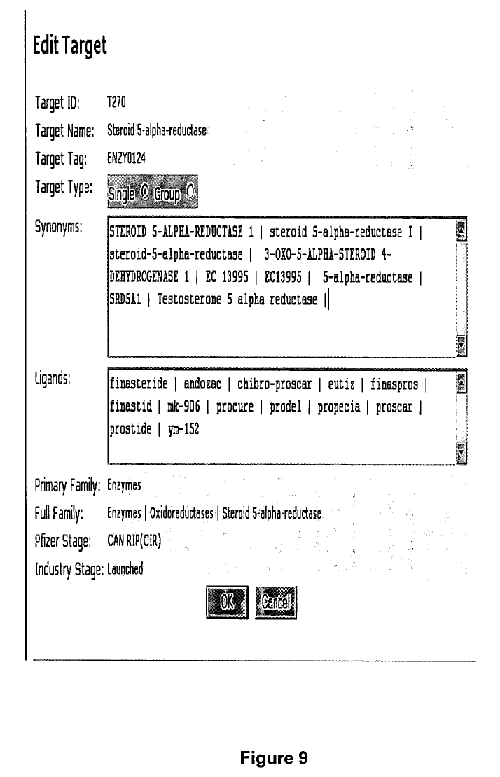

FIG. 7 illustrates the architecture of a system 700 supporting the pharmacological matrix in accordance with one embodiment of the invention. System 700 includes a database 750 of literature relating to pharmaceuticals, medicine, biology, medicinal chemistry, and so on. Note that database 750 may be provided as a relational database, such as Oracle 9i, an object-oriented database, such as Objectivity, a document management system, such as Documentum, a file system (as for UNIX or Windows), or through any other appropriate implementation. Furthermore, system 700 may have the ability to access material from multiple different databases and other data sources. For example, database 750 may provide access to patents, internal or proprietary documents, newsfeeds, company information, tables of chemical compound structures and their biological activity, as well as web-based data, which may be collected by any appropriate technique (e.g. spidering).

Database 750 is shown in FIG. 7 as including two articles or information items 751A, 751B, although it will be appreciated that the actual number of items in the database is likely to be extremely large. Thus in the current implementation, database 750 includes the MEDLINE literature system, which is a database compiled by the US National Library of Medicine that contains over 11 million records from more than 7300 different publications.

System 700 further includes a content based retrieval engine 730 that accesses items in database 750. An index 740 is provided to facilitate such access (this index may be maintained as part of the retrieval engine 730 or as integral to the database 750 itself). In the current implementation, the retrieval engine comprises the Verity K2 Enterprise product available from Verity Inc of California, USA.

Although retrieval engine 730 could be used on an ad hoc basis for processing user queries, for performance reasons that will become clearer later, system 700 generally precomputes query results, which are then stored into database 755. Accordingly, user queries are generally satisfied from database 755, rather than underlying data source 750. The information in database 755 is then updated on a periodic basis, for example weekly, although the update interval can be varied as required (e.g. daily, or after a certain number of updates have been made to database 750). Of course, in other embodiments, users might interact directly with database 750, thereby obviating the need to precompute any results.

System 700 also includes relational database 760, which comprises three tables, one for each axis in the pharmacological matrix. Thus a first table 761A comprises records relating to diseases, a second table comprises records relating to targets 761B, and a third table comprises records relating to compounds or drugs 761C. Each table stores the primary and ancillary parameters as well as the synonym information for the corresponding axis.

(It will be appreciated that the logical table model shown in FIG. 7 for database 760 may be implemented in practice in a variety of structures, involving differing numbers of tables. Likewise, the information for the various axes may be spread across two or more databases, or other appropriate data sources).

System 700 also has access to one or more external databases 765. These can be used to obtain additional information about items stored in tables 716A, 716B, and 716C. For example, with respect to target information 716B, system 700 may have a link to a gene database that provides a fill sequence listing for the gene corresponding to this particular target. Note that external database 760 may be (partly) internal to the pharmaceutical company, although external to system 700 per se, e.g. one such database might list which research groups within the company are working on which particular targets. System 700 provides convenient (and in some cases seamless) access to these databases, which can then be used to supplement and augment the findings of the Pharmamatrix system itself.

The two remaining portions of system 700 are a client portion 710, which in one embodiment is provided by a conventional Internet browser, and a server application portion 720. The server portion 720 defines multiple views 711A, 711B of the underlying data, which are defined to reflect the structure and intended workflows within the pharmacological matrix.

The server application portion 720 is responsible for formulating search queries, dependent upon the view chosen by the user, as qualified (e.g. filtered) by any particular user selections. For example, the user may request to see a certain type of data relating to a specified clinical area. The application portion 720 therefore has to access relational database 760 in order to retrieve a listing of diseases (including synonyms) corresponding to that clinical area. This listing is then used in performing the search of database 750.

FIG. 7A illustrates an alternative architecture for a system 700 supporting the pharmacological matrix in accordance with another embodiment of the invention. This alternative architecture provides the same query functionality as the implementation of FIG. 7, but does not pre-compute the results. Instead, it uses a grid computing paradigm, sometimes referred to as high performance computing or distributed computing, to deliver on-the-fly query responses. It will be appreciated that the embodiment of FIG. 7A is likely to become increasingly attractive as more and more powerful computers and computer networks become available.

In the embodiment of FIG. 7A, a search query from the web and application server 720 is first passed to a grid compute task distribution engine 776, which distributes the query to a compute grid 777 comprised of multiple computers (not individually shown in FIG. 7A). Each computer in the compute grid 777 contains a subset of the information otherwise held in database 750, with the sum of the information content of compute grid 777 corresponding to that of database 750. In addition, each computer in compute grid 777 includes a text mining application. One or more instances of this application are invoked by the grid compute task distribution engine 776 on each computer in response to the search query. (The grid compute task distribution engine 776 is also generally responsible for distributing additional or updated data to the compute grid nodes in compute grid 777). Results from querying the compute grid 777 are then returned to and collated by grid compute result processing engine 778, before passing back to the web and application server 720

It will be appreciated that compute grid 777 may comprise computers of varying compute capacities and running different operating systems, which may be dedicated to grid tasks or may be shared with other non-grid related tasks. The computer grid 777 is inherently scaleable to very large sizes, and so is able to provide search results in direct response to user queries in a reasonable time, thereby avoiding having to pre-compute query results. One advantage of this is that new information can be queried as soon as it has been loaded into grid 777, without having to wait for this data to be incorporated into the next set of precomputed search results. In addition, the architecture of FIG. 7A offers more potential for user customisation, rather than everyone having to use the same set of precomputed search results. This may be especially beneficial in relation to certain search and query techniques, for example involving semantic processing and higher order links (as described in more detail below), which may only be of interest to a limited subset of users.

In one particular embodiment, grid compute task distribution engine 776 may comprise Sun Grid Engine software, and compute grid 777 may comprise at least a Sun 6800 server and a Sun E450 server (all available from Sun Microsystems Inc.). The text mining implementation for processing the query may be implemented by the LexiMine product from SPSS, Inc. The result processing engine 778 may be implemented as a straightforward application to concatenate the results and to return them to the web and application server 720.

It will be appreciated that although the architecture of FIG. 7A may be used as an alternative to the architecture of FIG. 7, some systems may implement both approaches. In other words, such a system pre-computes results, but can also generate them on-the-fly. The precomputed results might then be available for most general users, with the grid components then providing a convenient way of running large scale ad hoc queries, asking more complex questions, and also for testing new data (such as synonyms) entered into the system prior to the periodic precomputation of the pharmacological matrix.

In constructing the system of FIG. 7 (and FIG. 7A), and especially in defining the three main axes of the pharmacological matrix as represented (logically) by tables 716A, 716B, and 716C, particular attention has been paid to three main aspects, in order to maximise exploitation of the literature database 750. Firstly, the system is designed to be as comprehensive as possible in terms of coverage of the different axes. Secondly, extensive synonyms have been provided in labelling the axes. Thirdly, the data is carefully curated, in order to detect omissions, duplications, etc (such curation exploits in part the various synonyms obtained). Note that these tend to be ongoing issues, so that database 760 is updated as and when new data, synonyms, etc become available.

With regard to the first of these aspects (comprehensiveness), a significant contribution to system 700 is the recognition that the universe of available pharmaceutical knowledge is finite. Consequently, such knowledge can be feasibly incorporated into and investigated by a single system. In particular, two of the axes in the pharmacological matrix are inherently limited, namely, the disease axis, which can be generated from appropriate medical encyclopaedia listing known diseases, and the target axis, which can be generated from genes sequenced as part of the human genome. The set of compounds for the compound axis is in contrast infinite (in theory). However, if the primary use of system 700 is to search for secondary indications, then the compound axis now also becomes finite, since it is restricted to compounds that are already known to have some pharmacological activity.

With regard to the second aspect, various information items may refer to the same underlying identifier in different terms, particularly where the information items come from a diverse range of heterogeneous sources. For example, one article may refer to the disease tuberculosis, but another to TB or to consumption or phthisis or Mycobacterium infection. Likewise, one article may use the chemical name of a drug, such as sildenafil, while another article may use the trade name (Viagra or Patrex or Penegra or Wan Ai Ke). Yet other papers may refer to the same compound as sildenafil citrate or UK-92,480 or UK-92480 or UK92480 or refer to it by its CAS registry number 171599-83-0 (or 139755-83-2 for the free base version). A further possibility is to use the chemical IUPAC name 5-[2-Ethoxy-5-(4-methylpiperazin-1-ylsulfonyl)phenyl]-1-methyl-3-propyl-6,7-dihydro-1H-pyrazolo[4,3-d]pyrimidin-7-one citrate. Similarly for targets, it is common the same biological entity, such as a protein, to be known by a variety of synonyms. For example the protein phosphodiesterase 5, could also be written as phosphodiesterase type 5 or PDE 5 or phosphodiesterase type V, or phosphodiesterase V or PDE V.

For each axis therefore, a thesaurus of synonyms has been developed. Each group of synonyms for a disease, target or compound has been assigned a unique identifier. This unique identifier is then used to provide a consistent location for information items pertaining to that disease (or other parameter(s)) within the pharmacological matrix. The use of synonyms in this manner can be applied to both the primary and ancillary parameters as appropriate. In addition, the synonyms of a particular entity may be grouped in a variety of ways, depending upon the particular ontologies and classifications systems employed.

In some embodiments it is useful for the synonyms of compounds that interact with a particular target to also be included in the list of synonyms for that particular target. This leads (for example) to the synonyms for phosphodiesterase 5 being combined with the synonyms for sildenafil (and/or vice versa).

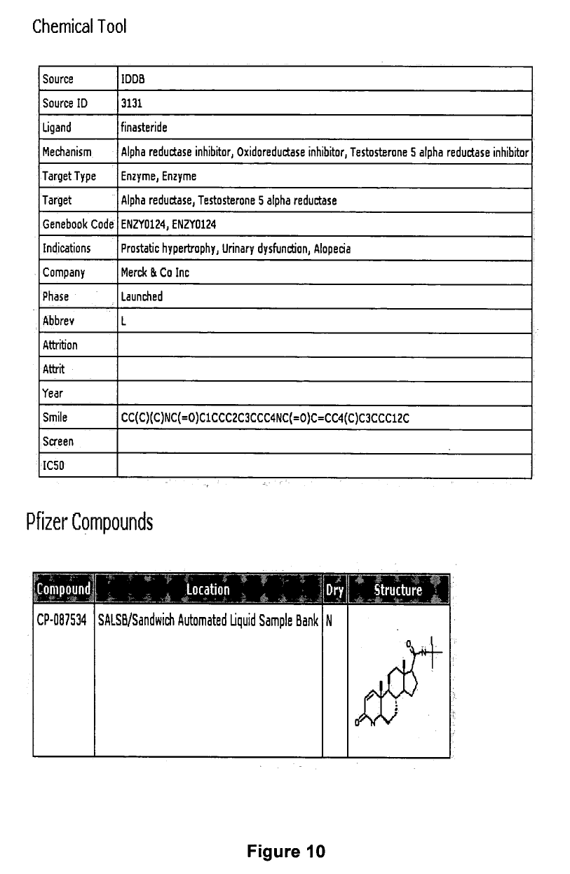

FIG. 8 illustrates a screen which may be used for adding a disease into system 700 (logically another entry into table 716A). The particular example shown in FIG. 8 corresponds to the disease malaria. This has been assigned the unique identifier I5182 within the pharmacological matrix. A variety of synonyms for malaria have been provided, including “plasmodium”, “plasmodium falciparum”, and so on.

Various ancillary parameters have been entered with respect to this disease, for example the class of the disease. Thus malaria is indicated as belonging to the anti-parasitic and anti-infectives disease areas, as well as being a neglected disease (an indication that it has been the subject of relatively little pharmaceutical research to date). In addition, malaria is indicated as having a medical need score of 4.88. This is a quantitative assessment of the medical value of developing a drug that is effective against malaria. A high medical need score would tend to indicate a large number of sufferers, a serious disease, and a lack of or problems with existing treatments. The “yes/no” button for “TA Interest” indicates that there is currently a therapeutic area looking at the disease malaria (i.e. it is indicative of current operations within Pfizer).

The disease relevant in vivolin vitro assay (DRIVA) field in FIG. 8 is used to provide a link to an external (in-house) database (such as represented by database 765 in FIG. 7). In particular, the DRIVA database contains information about assays that may be useful against malaria. This information can be accessed through the Pharmamatrix system.

The two remaining fields in FIG. 8 are primarily related to system operation, rather than being ancillary parameters per se. The “In Search” button simply indicates whether or not the record should be included in searches. Consequently, a record may be ignored for search purposes, without having to be deleted. This facility is typically used when creating and managing the database.

The “Search Terms” box is used if searching external databases that require predefined search terms (e.g. certain keywords), rather than being able to search on any given word. For instance, literature relating to malaria might be indexed in a particular database using the abbreviated term “MALR”, which would then be used for searching purposes. However, the literature database 750 utilised in the current implementation does not impose any limitations on search terminology, and so searches are conducted using the disease name plus the full range of synonyms. Hence no special search terms are provided in FIG. 8.

FIG. 9 illustrates a screen which may be used for editing a target entry within system 700 (logically an entry in table 716B). This particular example is for steroid 5-alpha-reductase, which is given the internal database name T270. A range of synonyms are provided for this target. In addition, a target tag is defined (ENZY0124), which is how the target is referenced in certain other in-house databases (although not in the medical literature in general). Ancillary parameters for this target include family information, which reflects one particular ontology for targets.

In addition, a set of ligands are provided. These are compounds that bind to or otherwise interact with the relevant target. It will be appreciated that these ligands are therefore compounds, and so link to the third axis in Pharmamatrix (for compounds). Note that these links represent connections that are already recognised in various formal industry databases, such as the Investigational Drugs Database (IDDB). In contrast, the searching capability of system 700 is aimed at finding potential links that are suggested in the wider set of literature, as represented by database 750, but that have not yet been fully recognised or exploited.

Two further ancillary parameters shown in FIG. 9 reflect the most advanced stage of any known drug (i.e. one of the listed ligands) against this target. In this context, stage denotes progress through the trials process, e.g. pre-trial, phase 1, launched, etc. This stage information is provided both for in-house developments, and also for the industry as a whole. This information is important, given that one of the primary objectives of the Pharmamatrix system is to search for secondary indications of existing approved drugs.

FIG. 10 illustrates a screen which represents a compound entry within system 700 (logically an entry into table 716C). In this particular case, the compound entry is for finasteride. This compound is listed as originating from the IDDB, and as having a particular reference within the IDDB. Ancillary parameters for the compound entry include the chemical formula (the Smiles field), as well as information as to the marketing status of the compound, and the owning company. The Attrition fields are used to provide information about a withdrawal from market (if any).

Further information provided for the compound entry includes links to both the other two axes of Pharmamatrix. Thus finasteride is indicated as being used against three indications, namely prostatic hypertrophy, urinary dysfunction, and alopecia. In addition, two targets for finasteride are identified, namely alpha reductase and testosterone 5 alpha reductase (which are both indicated as being enzymes). Information is also provided on the various known mechanisms whereby the compound interacts with its targets.

At the bottom of FIG. 10 is information retrieved about the compound from an external (but in-house) database 765. This additional information includes a structural representation of the compound, as well as details concerning whether or not a sample of the compound is held internally, and if so at which location.

Note that in the current implementation, synonym data for the compound axis is stored in a separate external database 765 rather than in system 700 itself, and is accessed as and when required. As an example of the listing of synonyms for a compound, those provided for finasteride include: CP-087534 (Pfizer Compound File), andozac (Trade Name), chibro-proscar (Trade Name), eutiz (Trade Name), finaspros (Trade Name), finasteride (USAN, BANN, INN), finastid (Trade Name), mk-0906 (Research Code), mk-906 (Research Code), procure (Trade Name), prodel (Trade Name), propecia (Trade Name), proscar (Trade Name), prostide (Trade Name), ym-152 (Research Code). Of course, it will be appreciated that in other embodiments, the compound synonym information could be stored in system 700 itself, along with the other data shown in FIG. 10.

The axis data for tables 716A, 716B, and 716C of the database 760 can be obtained from various standard sources, whether hard copy or on-line. Depending upon the data source(s), this information may have to be entered into database 760 by hand, such as by using the screens of FIGS. 8, 9 and 10, or it may be possible to enter at least part of the information automatically from an on-line source.

In the current implementation, the disease information is obtained from various medical dictionaries and encyclopaedia, such as the International Statistical Classification of Diseases and Related Health Problems Revision 10, ISBN 92 4 154419 8. Note that diseases can include conditions that may be unwanted for cosmetic or other reasons and which can potentially be treated or prevented by pharmaceuticals (e.g. baldness, pregnancy, etc). It will be appreciated that very obscure or rare diseases (e.g. that only affect people with an extremely uncommon genetic disorder) may be omitted from Pharmamatrix for reasons of practicality (such diseases would in any event be considered as having very low medical need).

The compound information is obtained primarily from the International Drugs Database (IDDB). This includes entries for publicly disclosed drugs at different stages of development. As previously discussed, the IDDB contains only a subset of possible pharmacologically active compounds, although it can be considered as largely complete for the purpose of searching for secondary indications of existing drugs. Of course, there are many other databases of chemical compounds available, and these could be added to system 700 if so desired.

Note that pharmaceutical companies tend to be particularly interested in drugs formed from small compounds, since these generally provide the most convenient and flexible medicaments. Thus small compound drugs can normally be provided in pill form for oral administration. In contrast, larger molecules, such as proteins, are typically unable to pass through the stomach wall and/or are broken down by enzymes in the intestine, and so often have to be administered by a less convenient route, such as injections. Accordingly, additions to the compound axis of the pharmacological matrix may focus preferentially on smaller compounds as being the most attractive for pharmaceutical development.

In terms of the target axis, one possible route for populating this is to utilise the full set of human genes sequenced as part of the human genome project. In the current implementation however, a somewhat different strategy has been used, which is to incorporate all targets that are known to have at least one drug active against them. This information can be derived from the IDDB and other similar sources, by extracting the target information for each listed drug.

One motivation for adopting this approach is that only a certain proportion of genes in the complete genome appear to be amenable to small compound ligand-binding, which is the conventional mode of action for most pharmaceuticals. Moreover, only a subset of these genes actually seem to have direct relevance for therapeutic purposes. For example, there is a lot of redundancy built into the genome, so that even if the behaviour of one gene is somehow modified, this alteration can often be compensated for or masked by other genes. Indeed, one estimate is that there may only be a few hundred genes that provide medically useful targets for small compound drugs (see A. L. Hopkins & C. R. Groom, “The Druggable Genome.”Nature Reviews Drug Discovery, 1, 727-730 (2002)).

In such circumstances, it is generally most efficient for the pharmalogical matrix to focus on those targets that are already known or suspected to be pharmaceutically relevant, based on the action of current drugs and drug candidates (as derived, for example, from the IDDB). Nevertheless, it will be appreciated that other embodiments may expand the target axis to accommodate the entire human genome (plus any other potential targets, such as the genome of known parasites).

As previously indicated, the data relating to the axes of the pharmacological matrix has been carefully curated (i.e. checked for consistency, etc.). The performance of this curation is routine for those of ordinary skill in the art, albeit somewhat time-consuming, since it is generally performed by hand. This especially applies to the creation of links between the different axes (such as the target field and the indication field shown in FIG. 10), where the terminology of the source databases has to be reconciled with the terminology adopted for Pharmamatrix. Consequently, synonyms are typically utilised during axis creation, as well as in subsequent searching of text database 750.

Although system 700 is initially populated during the development phase, it will be appreciated that by its nature the system is subject to further modification, in order to update or insert new information. Thus there is ongoing work to enhance the system, for example, to accommodate newly recognised diseases (e.g. the recent outbreak of the SARS virus), or newly discovered drugs, etc., or simply to add further synonyms that have been found in various papers.

It will be appreciated that once database 760 has been created, then it can be accessed using standard database technology. For example, views 711A 711B can be developed to perform selection (filtering) of specific records within the database, and of specific fields within the records. Results can then be presented with rows and columns ordered as appropriate.

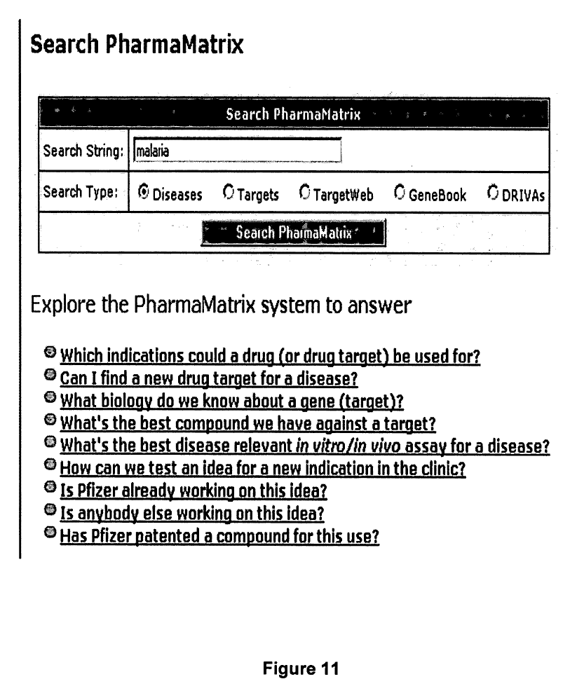

FIG. 11 illustrates a high-level user interface for the current Pharmamatrix system. This interface provides various predetermined mechanisms for accessing and processing the information in system 700 that are especially designed to facilitate the work of the intended user community. Of course, other implementations may provide different views and access mechanisms, especially if targeted at different sets of users.

As shown in FIG. 11, the Pharmamatrix top screen allows user input of a search string, and selection of one of 5 possible search types. Of these, the final three represent external (but in-house) databases 765, and so will only be discussed briefly herein. The DRIVA database has already been mentioned, and provides information about assay techniques. GeneBook is based on the set of genes sequenced as part of the human genome, and incorporates detailed information for the various genes (e.g. the DNA sequences of the different genes, polymorphisms, known or suspected functionality, and various other ontologies). Targetweb mirrors some of the information on the target axis, and provides information linking targets to compounds (ligands) and indications. Note that this information is based on data in public systems such as IDDB, and so corresponds to recognised associations. (In contrast, the Pharmamatrix system provides a facility to find new associations between compounds, targets, and indications).

The two remaining search types shown in FIG. 11 correspond to searching by disease and by target. In the current implementation, there is no specific searching by compound, in part because synonyms are used to overlap targets with compounds (see below). In other implementations however, searching by compound may be specifically enabled.

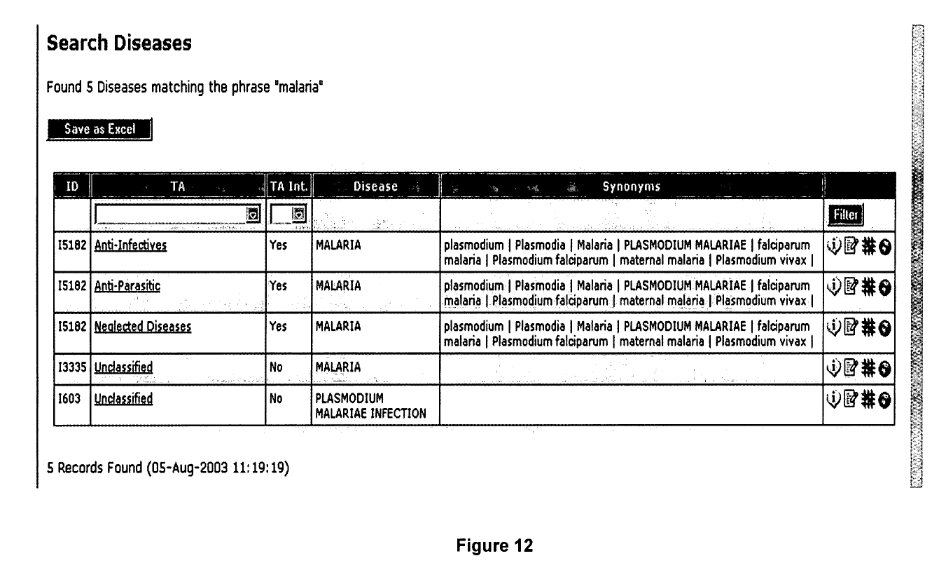

In the example shown in FIG. 11, the user has selected to search by disease, and entered the search string “malaria”. Hitting the “Search Pharmamatrix” button then results in the screen shown in FIG. 12. This screen is generated by searching the disease axis 716A of table 760, and lists the results by therapeutic area. Consequently, the disease malaria (ID I5182), as shown in FIG. 8, is shown three different times, once for each of its different therapeutic areas. The other two entries correspond to nominally different diseases (hence their different IDs), but are not indicated as being of therapeutic interest, and so will not be discussed further. (In fact, they are primarily artifacts of the data system, and so can be ignored).

To the right of each entry shown in FIG. 12 are four icons that can be used to process the entry further. The first of these (the “i”) is used to access information about the disease, such as shown in FIG. 8, plus the DRIVA (assay) information for the disease. The second icon (a notepad) is used to edit information about the disease via the screen of FIG. 8. The third icon (a grid) is used to search the Pharmamatrix system, as described in more detail below. The fourth icon (an egg) provides access to external information sources about the entry, such as an encyclopaedia entry for the disease, and the status of any clinical trials relating to the disease.

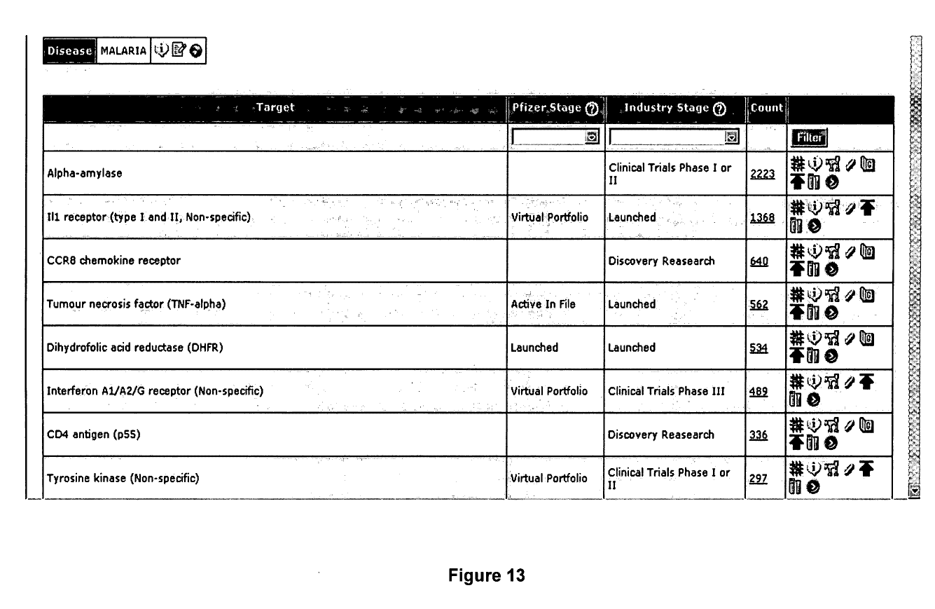

Assuming that the user selects the third icon, corresponding to a search of the Pharmamatrix system, this takes us to the screen of FIG. 13. (N.B. The same results are obtained, irrespective of which of the first three entries in FIG. 12 is selected, since they all correspond to the same disease ID).

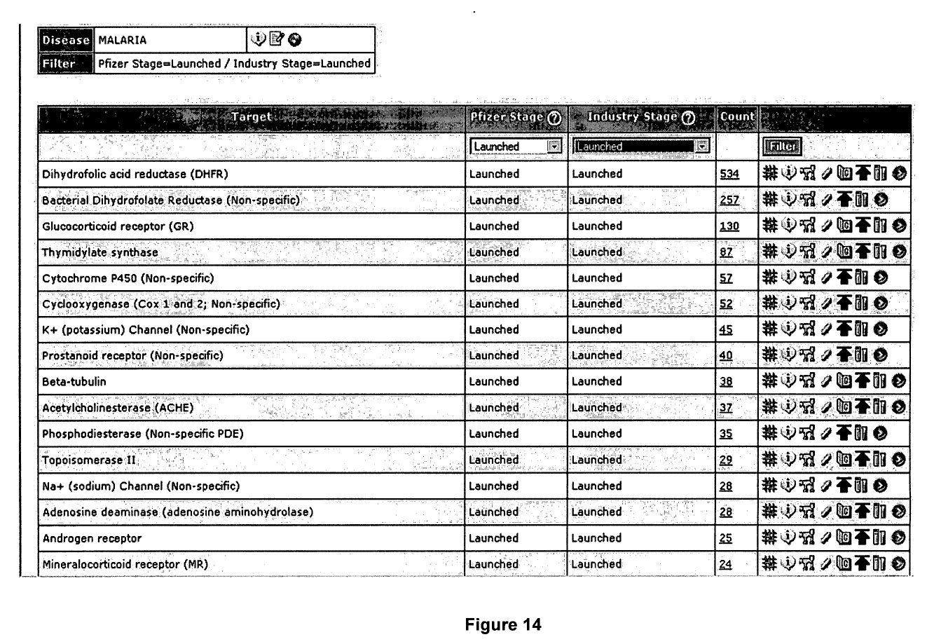

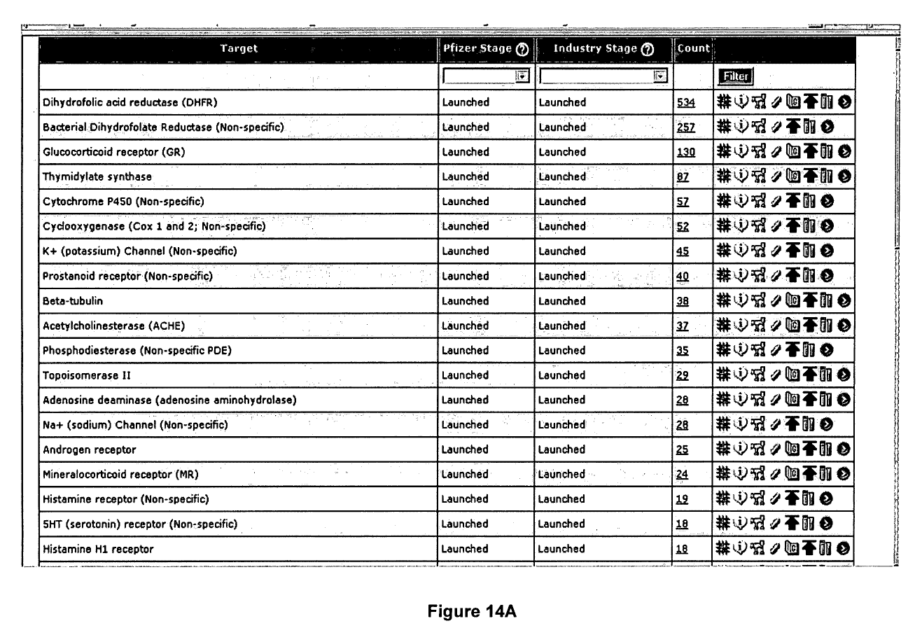

The results shown in FIG. 13 represent the outcome of searching the full-text database 750 (corresponding e.g. to Medline) for the disease malaria (as selected from FIG. 12). In particular, information items 751 are searched for mention of both (i) malaria, and (ii) any of targets in the system (i.e. in table 716B). The results are then presented by target, with those targets that are mentioned in most information items at the top of the list. Thus the database 750 contains 2223 information items 751 that mention both malaria and the target alpha-amylase, 1368 articles that mention both malaria and I11 receptor (type I and II, non-specific), and so on. (It will be appreciated that FIG. 13 shows only the first portion of the listing). For each target listed, the screen of FIG. 13 also details the progress towards marketing of the most advanced drug in respect of this target, both in-house and in general for all the industry. FIG. 14 presents a subset of the results of FIG. 13, but this time limited (i.e. filtered) to those targets for which Pfizer and the industry have a launched compound.

The amount of processing to generate the screen of FIG. 13 is considerable. For example, if there are say 10 synonyms for malaria, then a search must be done for each of these synonyms against each synonym of each target. If there are (say) 1500 targets in the system, and on average 20 synonyms per target, then this implies that a total of 300,000 searches are performed to generate the screen of FIG. 13.

In order to reduce response time, these searches are performed in advance, and the results stored into database 755. Accordingly, the information for screen FIG. 13 is promptly available to the user by simply retrieving the stored results from database 755, without having to wait for a very large number of searches of database 750 to complete. Of course, since the system does not know in advance what disease(s) a user will select, the precomputation has to be performed and stored for every disease in the system. A corresponding precomputation also has to be performed for every target (as will be described in more detail below). Note that in the current embodiment these precomputed searches are performed on a weekly basis, but any other suitable scheduling routine could be used instead.

Apart from computational difficulties, the very large number of articles available in a typical medical literature database 750 can cause other problems. In particular, there is a danger that a pharmaceutical researcher trying to investigate a particular disease suffers from “information overload”, given the vast number of available papers. For example, FIGS. 13 and 14 together present over 7000 papers relating to malaria, categorised by target. (There may be some duplicates here, if a paper mentions more than one target, although conversely, there may be many other papers on malaria that do not mention a target at all, and so do not appear on the listing).

However, the presentation of FIGS. 13 and 14, where the papers are grouped by target, greatly assists with the interpretation of the results. Those associations between target and disease at the top of the listings having high counts are clearly well-researched, and so presumably already investigated from a drug perspective. In contrast, the linkages lower down in the ranking with smaller counts may correspond to associations not previously appreciated in the pharmaceutical industry. These linkages might therefore suggest potential new lines of research.

Note the benefit here of using the curated lists to define the axes of the pharmalogical matrix. Thus taking as an example the numbers given above, namely 10 synonyms for malaria and 20 synonyms for a typical target, it will be appreciated that each row of FIG. 13 corresponds on average to some 300 different searches. Without the use of the curated lists and synonyms, these 300 searches would have to be performed separately and then collated together by hand; more likely, some of the synonyms would be omitted, and so only partial search results obtained. Accordingly, the curated lists for the axes allow a comprehensive investigation of database 750, while helping to reduce the results to manageable proportions.

Each target entry in FIG. 13 has up to 7 icons associated with it. The first icon (for matrix searching) is inactive, or at least, it simply repeats the screen of FIG. 13. The second icon provides information about the target (such as shown in FIG. 9). The remaining icons are primarily links to external databases 765 that provide additional information about the relevant target. For example, one of these icons links to GeneBook (see above), while another icon links to a database that details the top indications for which the target is used. The final arrow icon provides the set of synonyms for the target (as stored in table 716B, see also FIG. 9).

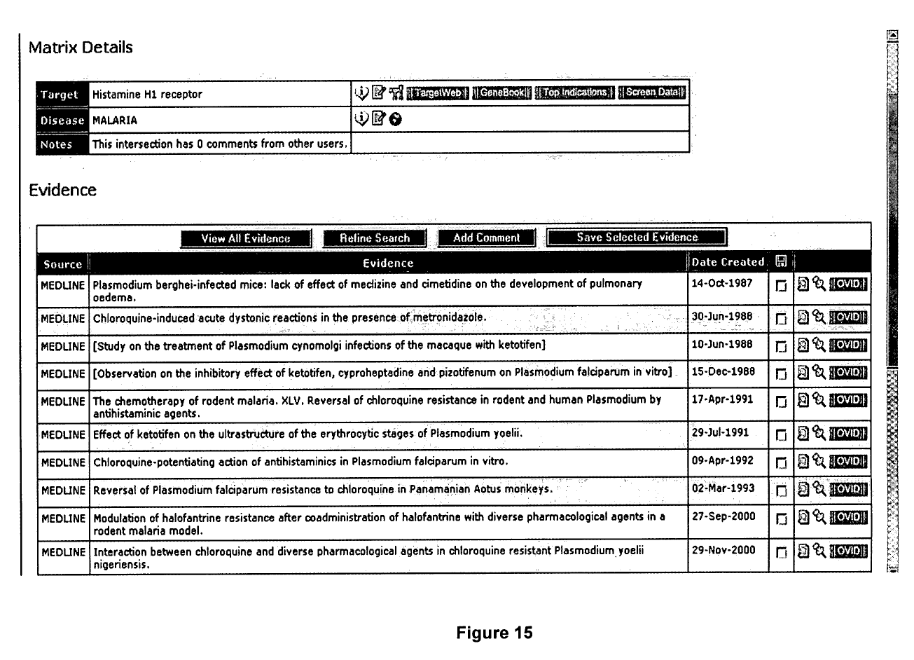

Selecting the Count column in the screen of FIG. 14 leads through to the screen of FIG. 15, which provides a listing of the information items 751 from database 750 that include the relevant search terms (or their synonyms). In the specific case of FIG. 15, these search terms are malaria for the disease, and the histamine H1 receptor for the target. Note that the number of articles linking malaria to this target was only 18, so that the entry for this target is not visible in FIG. 14. However, this entry can be accessed by scrolling down the listing of FIG. 14, to obtain the screen shown in FIG. 14A.

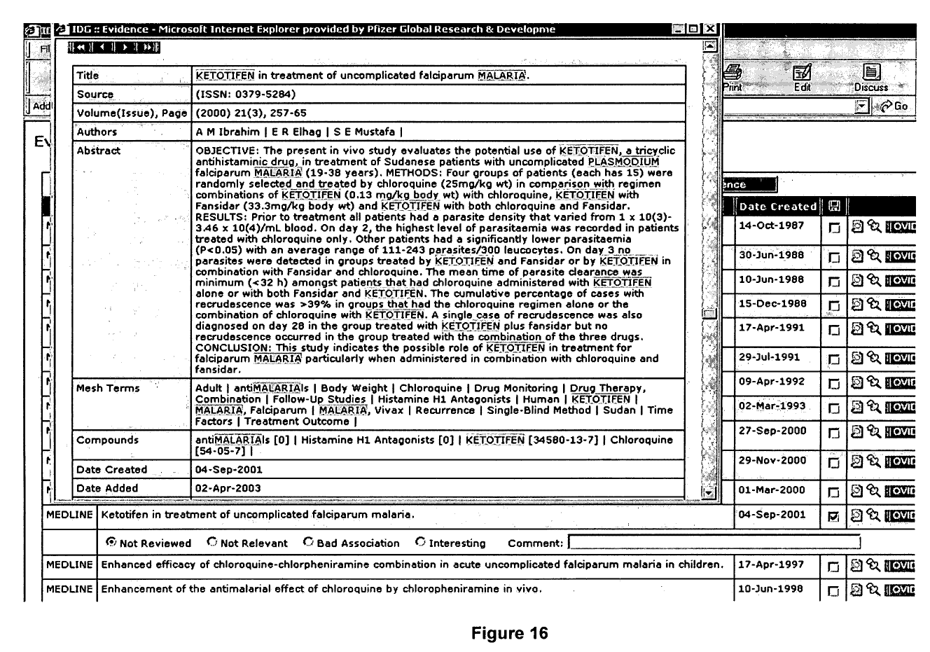

The entry for each information item in FIG. 15 has three icons to the right. The third icon is used to access the full text of the information item in question, typically from a web-based publisher. Selecting the first icon brings up just the abstract and bibliographic details for the information item (with the relevant search terms highlighted). This situation is illustrated in FIG. 16 for one particular article concerning the possible use of ketotifen for the treatment of malaria, where the abstract is displayed overlaid upon the screen of FIG. 15.

(It will be appreciated that ketotifen is a compound rather than a target per se. However, it has been found useful in the current implementation to include compounds that are known to act against a particular target as synonyms for the target itself—in this case ketotifen acts against the histamine h1 receptor. This then provides a direct mapping from disease to drug compound, as in the example of FIG. 16).

The second icon illustrated for each information item in FIG. 15 is a facility to add a note to the relevant article. Again, this facility is shown in FIG. 16 (for the same article on the possible use of ketotifen against malaria). As previously mentioned, the fact that a target (or compound) is referenced in the same article as a disease does not mean that the former is any use in treating the latter. For example, the presence of both in the same article may be coincidental, in which case the article can be marked as “Not Relevant” (for this particular association). In other cases, the information item may describe how the compound perhaps causes or promotes the disorder as a side effect, rather than suggesting that the compound could be used to treat the disorder. In this case, the linkage could then be marked as a “Bad Association”. On the other hand, it should not be assumed that this linkage does not have any pharmaceutical relevance. For example, an unwanted side effect in some circumstances (such anti-depressants causing a loss of sexual interest) might have a positive benefit treatment in other circumstances (for example, as a possible treatment against premature ejaculation).

In the particular context of FIG. 16, it is clear that the article is suggesting that ketotifen might indeed be useful for the treatment of malaria. Accordingly, the article might well be considered “Interesting” in terms of locating possible new treatments against malaria (this is not a recognised use of ketotifen). It will therefore be appreciated that the sequence of screens of FIG. 11 through to FIG. 16 suggest a secondary indication of the drug ketotifen against malaria.

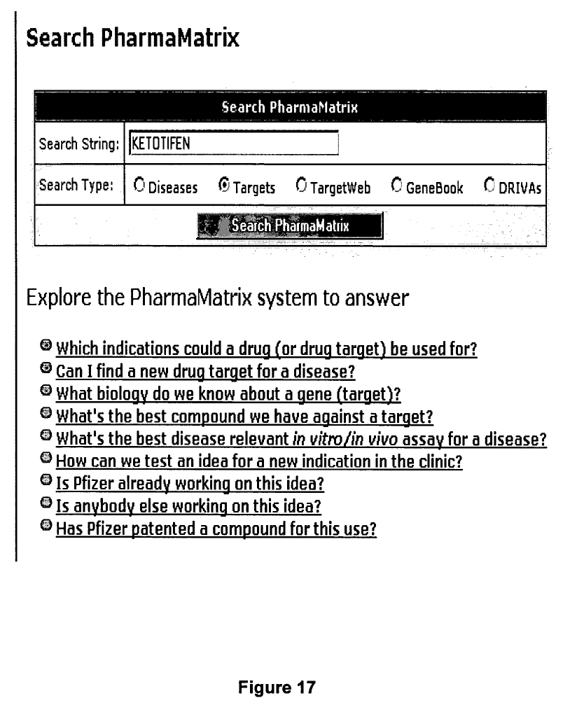

FIG. 17 returns us to the Pharmamatrix top-level menu, analogous to FIG. 11. This time the user has requested to search for targets using the term ketotifen. (As previously mentioned, the current implementation generally treats drug names as synonyms for the target(s) that they act against, which therefore enables searching for a target by drug name).

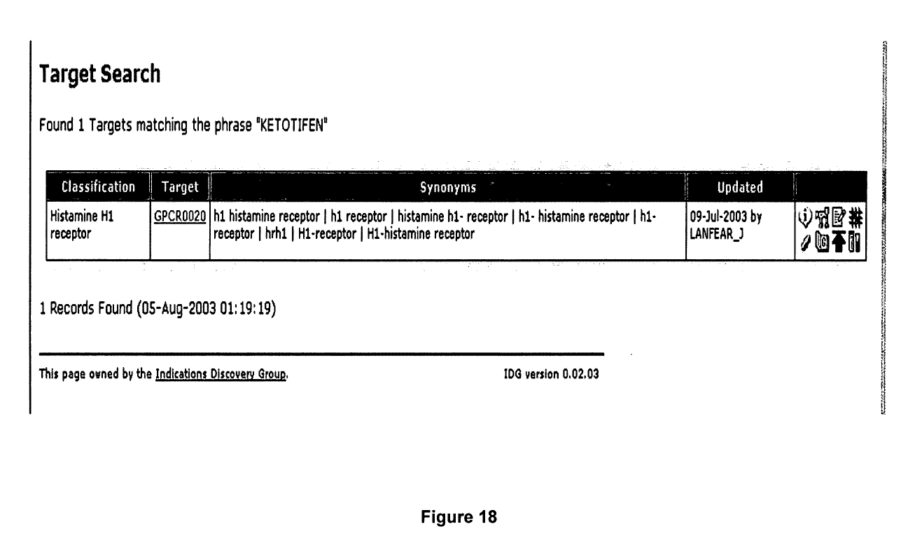

Hitting the Search Pharmamatrix button in FIG. 17 then leads to the target results screen of FIG. 18, which is broadly analogous to the disease results screen of FIG. 13. In terms of the icons provided, most of these link to external databases 765 relevant to the target in question. For example, the second icon links to a listing of compounds known to be active against the target (based on the ligands entered for that target, see FIG. 9), while the sixth icon links to GeneBook. The first and third icons are respectively for accessing and editing information about that target (as per the screen of FIG. 9), while the fourth icon is used to initiate a search of information items in database 750.

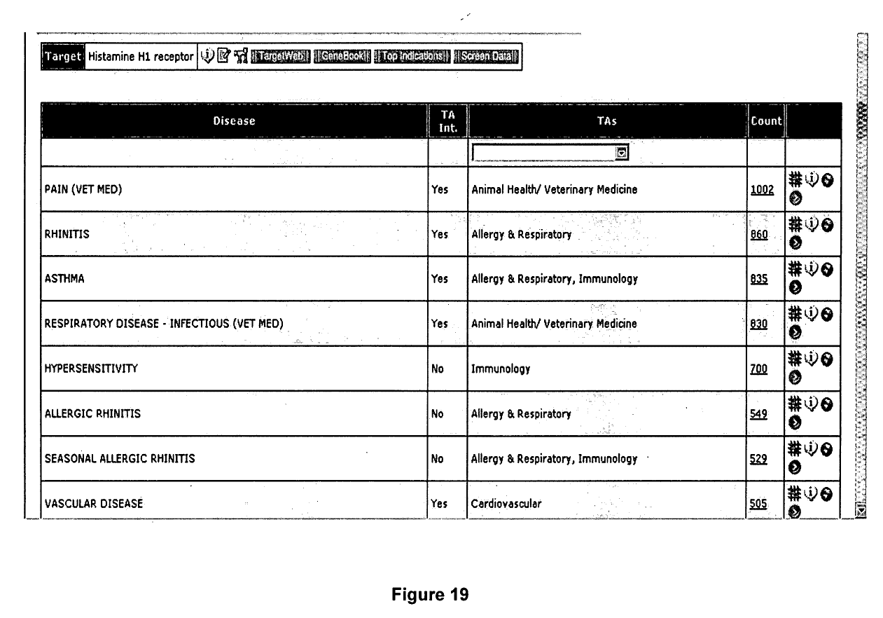

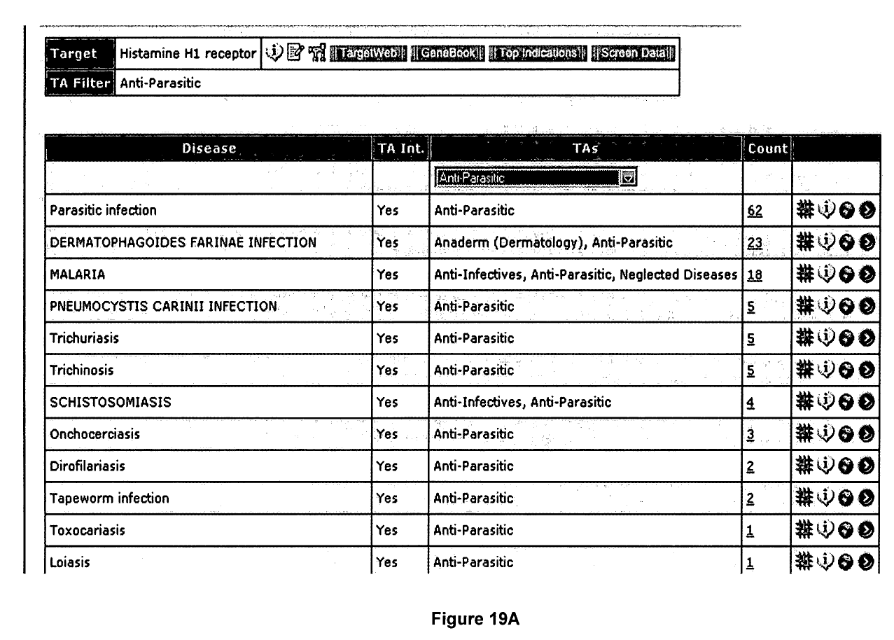

Pursuing this last option (i.e. selecting the fourth icon) leads us to the screen of FIG. 19. This can be regarded to some extent as the converse of FIG. 13, in that it lists the count of information items 751 for each disease that are related to the selected target (i.e. ketotifen). As would be expected, most of these relate to respiratory conditions, given that the histamine H1 receptor is well-known to be of relevance to such conditions.

As discussed in relation to FIG. 13, the results for FIG. 19 are precomputed, and stored in database 755 for performance reasons. Accordingly, in the current implementation, passing from the screen of FIG. 18 to the screen of FIG. 19 is accomplished by retrieving the relevant precomputed results from database 755, rather than by performing a fresh search of database 750.

Each entry in FIG. 19 has four icons, although the first is inoperative (it simply returns to the screen of FIG. 19). The second provides information about the disease in question (analogous to FIG. 8). The third icon provides links to external information and databases 765 relevant to the disease, such as a medical encyclopaedia entry, while the fourth icon provides the set of synonyms for the disease (as shown in FIG. 8).

FIG. 19A illustrates a subset of the data of FIG. 19, but filtered by therapeutic area to anti-parasitic. Note that 18 reference are cited for the disease malaria, matching the 18 references for the histamine H1 receptor shown in FIG. 14A. In other words, the same references are located whether searching first by disease (malaria), and then by target (histamine H1 receptor), as for FIG. 14A, or vice versa, as for FIG. 19A. In both cases, this leads to the set of 18 references shown (in part) in FIG. 15.

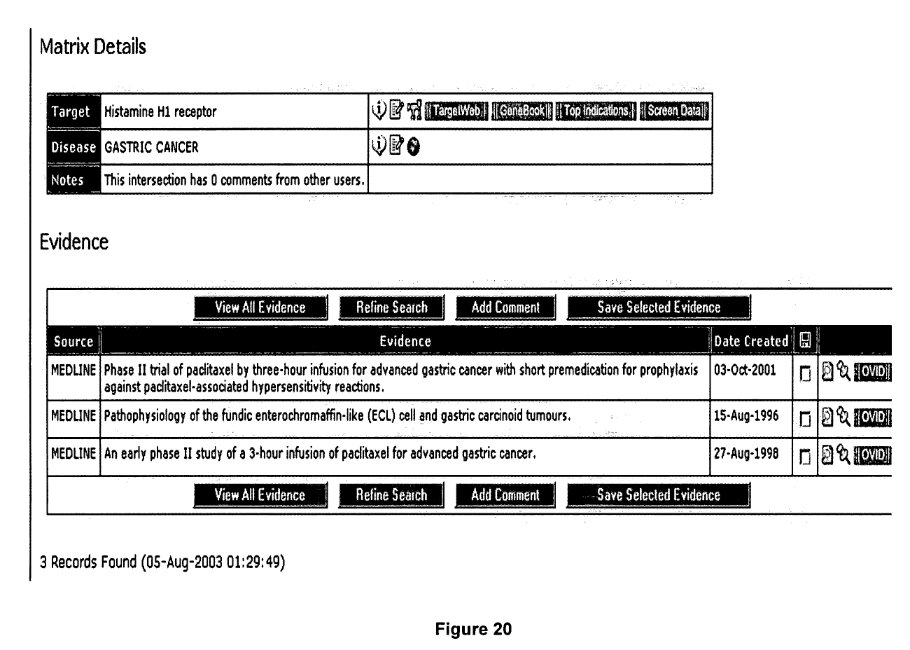

Returning to FIG. 19, selecting the Count column for a particular entry from the diseases shown (in this case gastric cancer, which can be accessed by scrolling down the listing of FIG. 19) leads through to the listing of articles shown in FIG. 20. This represents all the information items 751 from database 750 that mention both the target histamine H1 receptor and the disease gastric cancer (or their synonyms). It will be appreciated that the article listing of FIG. 20 can be processed in the same fashion as described above in relation to FIG. 15 in order to obtain abstracts and full copies of the articles concerned.

Returning now to the top screen of the Pharmamatrix system (see e.g. FIG. 11 or 17), the system also offers the user various questions to help them to decide the best strategy for their particular requirements. Of these, the first question, “Which indications could a drug (or drug target) be used for” mirrors the search by target strategy just described in relation to FIGS. 17 to 20.

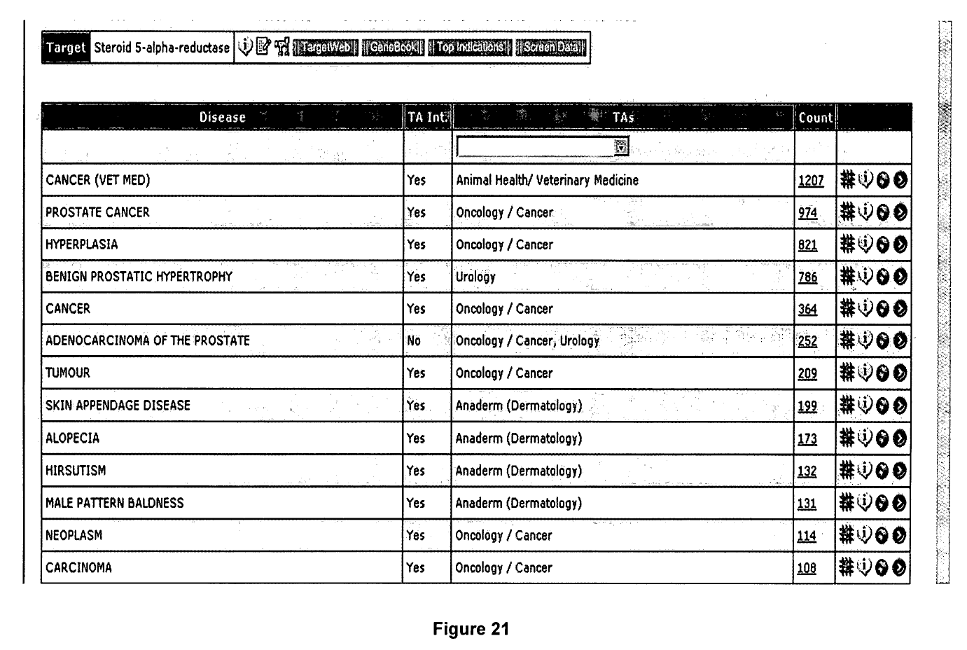

A further example of performing such a search, which could be followed by selecting this first question, is illustrated in FIG. 21. This is analogous to FIG. 19, in that it shows the number of hits by disease for a particular target, in this case steroid 5-alpha reductase. In view of the use of this target by the drug finasteride discussed above, there are a significant number of articles relating this target to various diseases, including prostrate cancer, hyperplasia, and also alopecia and baldness.

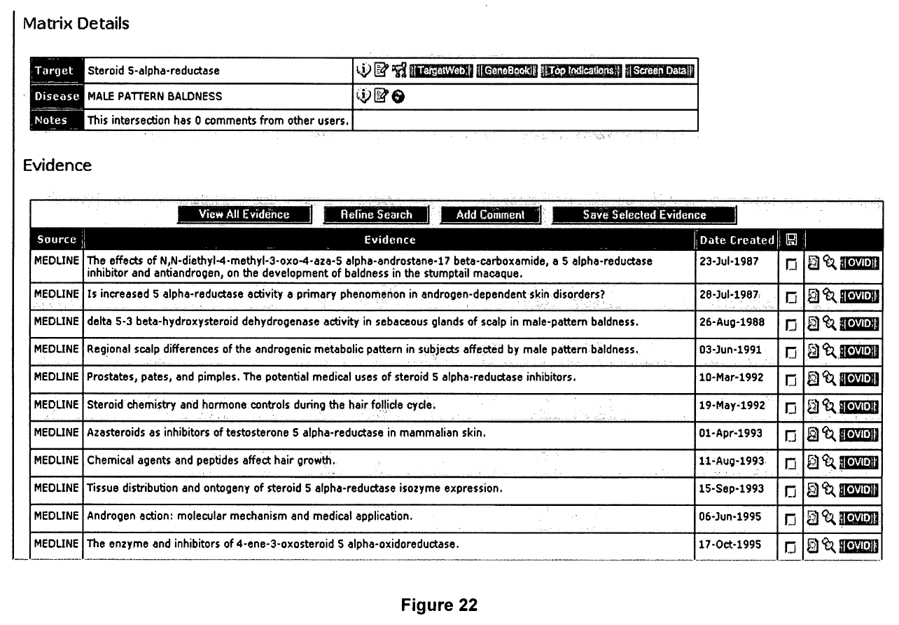

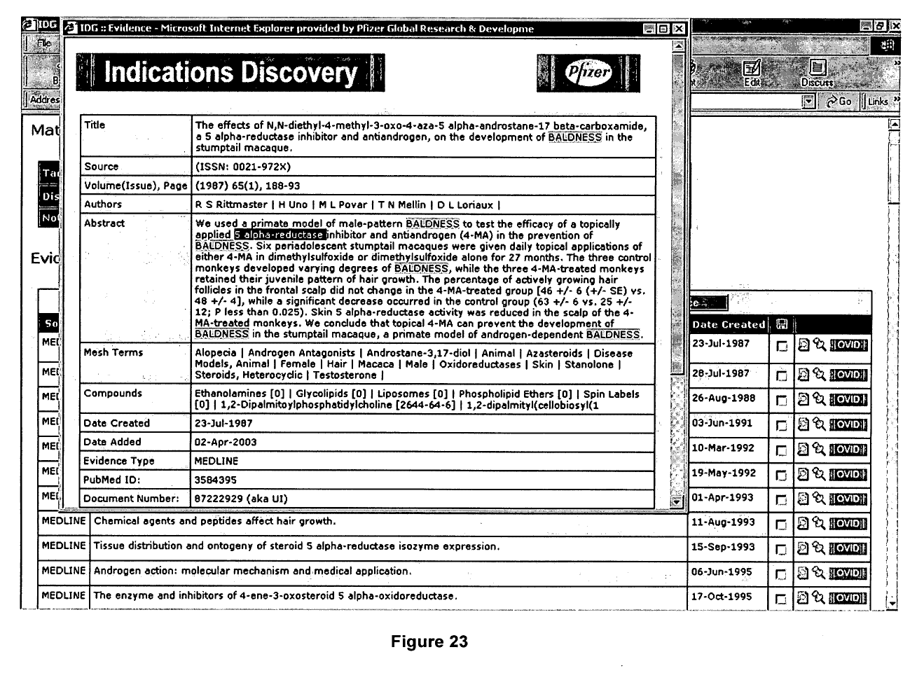

FIG. 22 lists the information items 751 from database 751 that specifically link the target steroid-5-alpha-reductase to the disease male pattern baldness (i.e. this is the screen that is obtained by clicking on the Count column for the male pattern baldness row in FIG. 21). FIG. 23 then shows the abstract of the first article in this listing. Interestingly, it is clear from the article that there were suggestions at least as far back as 1987 that this target had potential relevance to the treatment of baldness.

Returning to the top menu (see FIG. 11 or 17), it will be appreciated that the second question on the list, can I find a new drug target for a disease, corresponds to the search by disease, described above with reference to FIGS. 11 to 16. (In that particular case, the search uncovered the potential for using the histamine H1 receptor and drug ketotifen for the treatment of malaria). The remaining questions listed in the top menu provide mechanisms for accessing external databases 765 rather than searching information items within database 750, and so will not be described in detail herein.

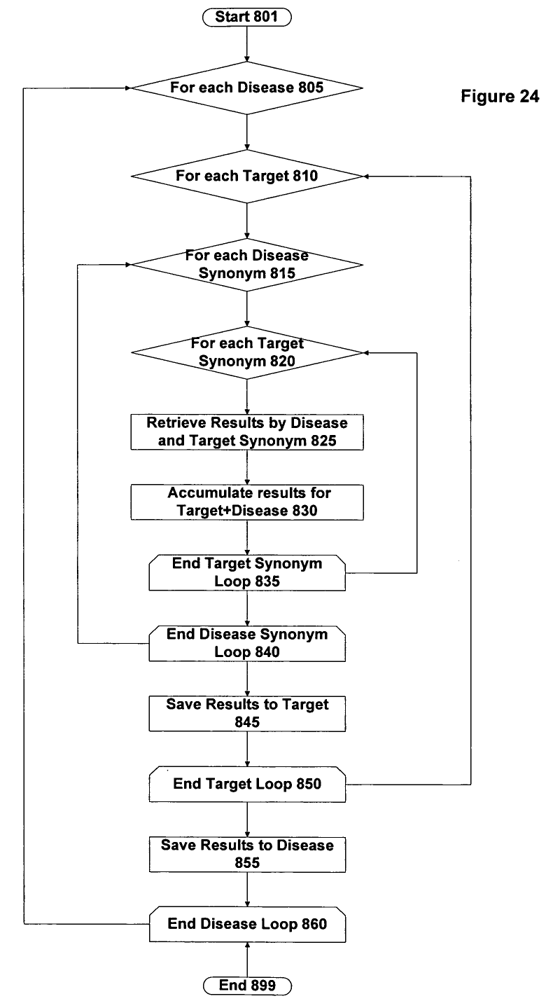

FIG. 24 provides a flowchart that illustrates the precomputation of search results in accordance with one embodiment of the invention. The procedure depicted takes each disease in turn, and produces the data corresponding to that shown in FIG. 13 for the disease in question.

More particularly, the method starts at step 801, and proceeds to loop first by disease (step 805) and then by target (step 810). For the relevant disease-target combination, the method now loops by disease synonym (step 815) and by target synonym (step 820). Within the innermost loop, search results are retrieved from database 750 for the relevant combination of disease synonym and target synonym (step 825). These results are then accumulated for the particular target-disease combination (step 830).

Note that the form of search at step 825 may vary according to the particular embodiment. In the current implementation, the database 750 incorporates abstracts and other bibliographic information (rather than the full text of the articles). Accordingly, the searches are performed within the available abstracts and fields. However, in other embodiments the full text of the articles may be available for searching.

In addition, the precise data retrieved at step 825 may vary from one implementation to another. In one embodiment, only a reference is retrieved to a matching article (i.e. an article that contains both of the search terms). This reference can then be stored in database 755, thereby allowing other information about the article to be readily accessed in the future. In an alternative embodiment, the system 700 retrieves and stores in database 755 all information needed to populate the screen of FIG. 15 (i.e. title and creation date), as well as a reference back to the full set of data in database 750. A further possibility would be to retrieve and store the complete abstract and bibliographic details shown in FIG. 16 in database 755, although in this case the amount of pre-computed data would be very large.

Once all the results have been accumulated for all synonyms of a given disease-target combination (steps 835, 840), they are counted and saved to the particular target. This can be viewed as completing one line of FIG. 13. The method then proceeds to obtain data for all other targets associated with that disease, i.e. to fill in the remaining lines of FIG. 13. Once this has been completed (step 850), processing continues to the next disease, i.e. to generate the equivalent of FIG. 13 for other diseases. Once such results have been obtained and stored for all diseases (steps 855, 860), processing can terminate (step 899).

The processing of FIG. 24 therefore enables the results shown in FIG. 13 to be precomputed for all diseases. An analogous procedure can be used to precompute the results shown in FIG. 19 for all targets. One way of implementing this latter precomputation is based on FIG. 24, but simply interchanging disease and target in the various operations. Alternatively, rather than having two completely different retrieval procedures, it will be noted that the inner retrieval and accumulation for a particular target-disease combination at steps 815 through to steps 840 can be used for generating both FIG. 13 and FIG. 19. Accordingly this inner loop might only be performed once, with the results then being manipulated as appropriate to precompute both searches by disease (as in FIG. 13) and also searches by target (as in FIG. 19). Note that this manipulation may be performed as part of the advance precomputation, and stored in database 755. Alternatively, the precomputed results may be stored as a set of disease-target combinations in database 755, thereby allowing the search results by disease or target to be assembled dynamically from the relevant combinations as and when required in response to a user query.

It will be appreciated that the general processing of FIG. 24 can also be employed for ad hoc queries using the system of FIG. 7A. However, in this case the outer loop of processing in FIG. 24 is generally omitted—i.e. processing is limited to a single disease or to a single target, depending upon the user query.

Although the current implementation of Pharmamatrix provides certain predetermined usage strategies, it will be appreciated that there is a very wide range of other investigations that may be performed with the system 700. Such investigations may be performed either by the development of additional views 711, or by using standard database access facilities to access the data in the relevant databases, or by any other appropriate mechanism.

For example, a facility could be provided to search by compound (although to some extent this is obviated in the current implementation by the provision of compounds as synonyms for targets). This would ensure that the order in which the data in system is accessed is arbitrary and can be selected by a user at the time of submitting a query. In particular, it would be possible to enter initially from the compound, target or disease perspective and then to extend the analysis along any axis.

The results of a compound search could be categorised either by disease or by target. The former option would produce a view resembling that of FIG. 19 (except that it would be particular to a compound rather than a target), and provides a mechanism to search for secondary indications for a particular compound, analogous to the strategy illustrated in FIG. 6.

The latter option, mapping a compound against all targets, can be employed for the discovery of new drug targets associated with a drug, and thus can be used as a way of virtual screening. It is not uncommon to discover that a drug binds to more than one target. The drug action of the second target may elucidate the mechanism of action of a new indication, pharmacological property or toxicological (safety) concern.

The system so far described produces a simple yes/no for each information item, according to the sole criterion of whether or not the relevant textual search terms appear in the information item. As previously mentioned, this process identifies a variety of connections between axes. For example, in a search of disease A against compound B, the presence in a single information of both disease A and compound B might potentially be due to one (or more) of the following reasons:

(a) compound B is potentially effective as a treatment against disease A;

(b) compound A has no effectiveness as a treatment against disease A;

(c) disease A is a side effect of taking compound B for some other purpose;

(d) compound B increases (or decreases) vulnerability to disease A; and

(e) compound B is potentially effective as a biomarker for disease A (e.g. the presence of compound B in the bloodstream is indicative that the patient is suffering from disease A).

The above list is not exhaustive. One other possibility is that the mention of A in combination with B may be purely coincidental and have no direct pharmaceutical relevance: e.g. some people in a trial were observed to have disease A, and some disease C, and some of those with disease C were taking compound B for treating disease C. In other cases, the form of interaction may be somewhat more complex, but potentially of interest: e.g. when treating disease A with compound D at the same time (and in the same person) as treating disease C with compound B, the effectiveness of compound D might be reduced (or enhanced).

It will be appreciated that analogous sets of possible relationships exist between the compound and target axes, and also between the target and disease axes. Accordingly, Pharmamatrix can be used to search for a wide range of classes of interaction. For example, the system can be employed not just for finding targets or compounds that might be used to treat a particular disease, but also for identifying targets or compounds that might be useful as a biomarker for that disease.

Rather than simple yes/no counting based on the presence (or otherwise) of the selected search terms, a more sophisticated analysis of the information items could be performed. One possibility is to estimate a relevance, weight or confidence for each information item by using the bibliographic information—e.g. precedence might be accorded to more recent articles, or to those in certain more prestigious journals. The text of the article (or abstract) can also be used for determining relevance. For example, the presence of a search term in the title of an article generally indicates a higher relevance than simply having the search term in the abstract (or main text) of an article. Likewise repeated mentions of the search term generally indicate a higher relevance and confidence than a solitary mention. The absence of other search terms might also indicate a higher degree of relevance for the particular search term that is present (although this is computationally more time-consuming to determine).

More specialised criteria for assessing relevance can also be used. For example, papers that report results from human trials could be given precedence over results from animals trials, which in turn could be given precedence over in vitro experiments. This form of assessment might be made by simply searching for predetermined words or phrases in an information item (e.g. “animal trial”). This approach could be formalised by building a dictionary or vocabulary of key words to be used in ranking (or filtering) articles. Alternatively, a more complex semantic analysis might be performed (natural language processing).

Further methodologies and criteria for assessing relevance are known to the person of ordinary skill in the art (such as those used in Internet search engines). It will be appreciated that the various techniques for assessing relevance may be combined as appropriate.

If relevance information is determined it can be utilised in various ways. For example, a listing of articles, such as shown in FIG. 15, might be ordered or ranked by relevance. This might be done implicitly (i.e. without exposing the actual relevance scores to a user), or explicitly, by having relevance as another column in the view, and permitting the listing to be ordered in accordance with this column (perhaps as the default). Another possibility might be to simply omit (i.e. filter out) articles from the view that have a relevance less than some threshold (potentially user-definable).

The relevance information might also be used in relation to the view of FIG. 14. For example, the Count column might be replaced or supplemented by a column reflecting the sum of the relevance figures for the information items in that row of the listing. Alternatively, the relevance column might reflect the highest relevance value for any information item in that row of the listing.

As previously discussed, FIG. 14 represents a filtered view of FIG. 13, in that FIG. 14 only includes compounds for which a marketed drug is available. There are many possible criteria for performing such filtering, including:

(a) language of the information item (e.g. a user might only be interested in locating English language articles);

(b) application area (such as whether relevant primarily for human treatment or for veterinarian uses);

(c) source of information (e.g. limiting the text search to articles from a defined group of journals recognised as having particular importance);

(d) mode of available compound delivery (such as whether available in a form for oral administration); and

(e) patent situation (including status and ownership of any relevant patents).

Note that the filtering may be applied at various stages of the analysis. Thus in some circumstances, the filtering may be applied, prior to the search, to the data of the relevant axis 716, utilising the relevant ancillary parameters. (This is the case for FIG. 14, which can be derived using the “phase” shown in FIG. 10). In other circumstances, the selection may be applied during search and retrieval of the information items themselves from database 750. (This might be appropriate for filtering by language, for example).

The various filtering criteria may also be used after the search, for ranking the results. For example, an article in a prestigious journal might be valued ahead of an article in a less prestigious journal when assessing relevance. Similarly, drug compounds available in pill form might be ranked above drug compounds that have to be taken intravenously.

Some of the techniques discussed for filtering or ranking (assessing relevance) can also be helpful in automatically allocating information items to one of the possible types of relationship listed above (as (a) to (e)). Again, this filtering might simply be based on scanning for certain words (e.g. “treatment”, “marker”, etc), and/or by performing a more complex semantic analysis.

Note that data and ontologies relating to the axes (as held in database 760) can also be used in determining and enhancing the relevance of results. Thus one possibility might be to provide the user with an option to filter out recognised associations. For example, referring to FIGS. 9 and 10, it is already known that finasteride is associated with the steroid 5-alpha-reductase target and with prostatic hypertrophy, urinary dysfunction, and alopecia. Accordingly, if the user is looking primarily for new indications, it may be beneficial to be able to filter out such existing indications from the view of FIG. 21 (i.e. so that the entry for alopecia would be perhaps be omitted or otherwise masked out as an existing indication). This would then allow a user to focus more clearly on new indications. As previously mentioned, information about such known linkages is accessible from various databases, such as IDDB, as well as being stored in certain ancillary parameters of the Pharmamatrix axes 716 themselves, and this might then be used to drive the desired filtering.

Another example of the use of axis data to determine relevance is where the ontology of the axis provides some mechanism for weighting the search results involving that axis. For example, as previously indicated, not all genes are susceptible to small compound binding. Consequently, one might establish an ontology for the target axis based on one or more parameters such as druggability (i.e. how likely a small compound binding is to be found for the target) and therapeutic usefulness (i.e. whether interacting with the target is expected to impact biochemical behaviour). Such parameters can potentially be estimated from research into the human genome, for example, and then used to limit or to order the search results. For example, the target entries in the view of FIG. 14 might be ordered in accordance with estimated druggability of the target.

Note that in FIG. 14 one ontology of the target axis is already being used for ordering, in that only targets having launched drugs are listed. Targets not having launched drugs are excluded (this can be considered as assigning such targets zero relevance). Likewise, medical need might also be used for determining the relevance of search results.

In one implementation, the Pharmamatrix system can be used to map one axis onto itself. This might be used, for example, to derive a listing analogous to FIG. 14, but where the disease malaria is mapped onto other diseases rather than to targets. In other words, for each of the various diseases along the disease axis (i.e. as present in table 716A), the system would search for information items in database 750 that mention both malaria and the disease in question. The results could then be presented by disease, ordered according to the number of documents that cite both malaria and the disease in question (i.e. generally analogous to the presentation of FIG. 14, but for a disease against disease mapping).

Investigating the disease-disease mapping locates information items that reference multiple diseases, and can be valuable in uncovering co-occurring diseases or other disease or epidemiological associations. Such disease-disease associations can then be mapped onto biochemical pathways to reveal previously unknown biochemical or molecular pathways, or to find environmental or infectious agents as a common pathology between two or more previously unconnected diseases.

Similarly, calculating a target versus target matrix locates information items that contain a link or association between two different targets. Such target versus target information can be valuable for elucidating protein-protein interactions or for uncovering synergies that might be the basis for combination therapies. In addition, a compound-compound mapping may be used to find links or associations between drugs, which can be valuable for identifying potential combination therapies.

The mappings described so far have generally been:

(i) two-dimensional—in other words finding information items that pertain to X and Y (where X and Y may be taken from the same or different axes); and

(ii) first order—in other words, the retrieval for X and Y looks for information items that directly contain both X and Y.

However, the Pharmamatrix system may be expanded to relax both these constraints if appropriate.

For example, in some circumstances three-dimensional mappings might be utilised to find information items pertaining to X, Y, and Z (again X, Y, Z may be taken from the same or different axes). There are various ways in which such a multi-dimensional query might be formulated. For example, searching for articles that mention a particular disease, target and compound, listed perhaps by compound, or articles that mention a disease and two particular targets, listed perhaps by disease.

Similarly, Pharmamatrix might be searched for second or higher order associations. Thus if X and Y both appear in (or are otherwise linked by) a single article, there is a first order link between X and Y. A second order link between X and Y then occurs if there is a first order link between X and Z and another first order link between Z and Y (with higher order links defined analogously). An example of a second order search might be to locate a second order link between a compound and a disease, where the compound has a first order link to a target, and there is also a first order link from the target to the disease.

It will be appreciated that output in the current implementation, such as shown in FIG. 14 or 15, is largely list-based, rather than graphical (as per FIGS. 1-6). The list-based approach is especially convenient for several reasons, including the large number of data points and the generally textual nature of the underlying data. This latter aspect implies not only that a textual representation of an individual data point is most appropriate, but also that the spatial ordering of data along the axes may be of comparatively little value. In other words, the inherent properties of the data tend to correspond more to a listing than a graphical plot.

Nevertheless, it will be appreciated that a graphical presentation provides a valid representation of the underlying data, and accordingly may be utilised as appropriate for the particular circumstances. For example, if targets are ordered in correspondence with location on the human genome, then spatial location of various target along the target axis might possibly have pharmaceutical relevance. This could then be investigated visually on a graphical plot, or by using statistical (spatial) clustering or other such analysis techniques.

Furthermore, in the embodiments so far described, the compound axis 716C has primarily been defined on a textual basis, by using the names of the relevant compounds. However, in other embodiments non-textual parameters might be utilised, such as chemical structure. Note that some information about structure is already stored on the compound axis (see FIG. 10), and there are various ways in which this might be exploited.

One possibility is to impose a structure-based ontology onto the presentation of results. For example, if the system supports a view of search results by compound (analogous to the view by target of FIG. 13), then these results could be ordered by structural groups (rather than say number of matching references, although of course number of matching references could be used as a secondary ranking parameter within each structural group). In addition, evidence could potentially be summed within each structural group. Such presentations might perhaps reveal that a certain structural group is common to many compounds that are all apparently related to a specified target. This evidence would then suggest that this particular structural group is responsible for a chemical interaction between the compounds concerned and the specified target.

Another possibility is that information on chemical structure could be used during the search itself, rather than simply in the presentation of search results. For example, searching for a given compound already incorporates searching for name synonyms of this compound. This concept of synonyms could be extended to include searching for chemical homologues or analogues of the specified compound (i.e. to include compounds that are closely related from a structural or chemical perspective to the compound to be searched).

There are various ways in which such searching of structural synonyms might be implemented. In certain embodiments, database 750 might directly support searching for structural synonyms. In other words, a chemical structure might be input as a search term, and database 750 would have the ability to match to corresponding or similar structures.

Alternatively, structural synonyms might be handled in a similar manner to name synonyms. In other words, a listing of compounds that are structural synonyms of the compound to be searched could be generated, with each entry in the listing being separately searched, and the results then collated for the entire listing. The information for deriving the listing of structural synonyms could be incorporated as one or more ancillary parameters within the compound axis 716C. Alternatively, this might perhaps be implemented by a dedicated tool that accepts a compound name, and then returns a listing of compounds having a structural similarities to the originally provided compound. Such a tool could interface as appropriate to system 700, such as to compound axis 716C or search engine 730.

There are a number of potential uses for the ability to accommodate structural synonyms. One possible situation (as contemplated above) is where results may be summed across a set of structural synonyms to provide stronger evidence for an interaction than can be obtained from any one compound within this group. Another circumstance is when a certain drug is known to be pharmacologically effective, but to suffer from disadvantages (e.g. high toxicity). In this case, the database might be searched for evidence to support the use of a compound that has structural similarities to the known drug, and so might possibly share its efficacy, yet might not suffer from its disadvantage(s).

On the other hand, there may be situations where it is nevertheless desirable to perform a search solely in relation to a specific compound, without including structural synonyms. Accordingly, the facility to include structural synonyms could be made optional, whereby it can be switched on or off for any particular view or search.

The above techniques for investigating structural synonyms could also be implemented on the target axis, based typically on similarities in DNA sequences in genes, or amino acid sequences in proteins. Such a facility could be used for example to identify compounds that are known to be effective against targets that are structurally synonymous with the particular target under investigation (and so might also be effective against this target). Note that suitable facilities for identifying similarities in gene sequences already exist, such as the BLAST algorithm mentioned above.

In one embodiment of the invention, the Pharmamatrix system is extended to support further axes in addition to (or potentially instead of) disease, compound, and target, such as axes for anatomy, tissue type, cell type, or experimental methodology. It will be appreciated that the entities for an axis for anatomy, tissue type, and cell type can be readily derived from medical encyclopaedias and other references sources, and can be constructed in a relatively complete fashion. The total number of entities on such axes is somewhat smaller than on the disease or target axes (typically hundreds rather than thousands).

As an example of the use of such additional axes, there may be a report in the literature that a particular drug tends to accumulate in a certain part of the anatomy (say the brain) or in a certain tissue type, even if this does not appear to cause any adverse medical condition (i.e. no disease). The accumulation may be irrelevant to the primary indication of the drug, which may perhaps relate to heart medication. However, the accumulation of the drug in the brain may be of potential interest to a researcher who is looking for a mechanism to deliver a different compound to the brain. The report of the drug accumulation in the brain could then be found within the Pharmamatrix system by searching along the compound axis for the anatomy entity of “brain”, analogous to the search performed along the compound axis for the disease entity of malaria (see FIGS. 12-16).

The pharmaceutical investigations described above have been mainly presented in the context of human medical applications, but can also be applied to veterinary medicine. In this case, appropriate other sources of information can be utilised for defining the axes of the Pharmamatrix system, and also for the providing the database(s) of information items to search. One particular benefit of being able to handle both human and veterinary medicine is the ability to discover linkages between human diseases and animal diseases, for example by searching with human diseases on one axis and animal diseases on another. This may be especially significant in terms of certain infectious diseases (such as BSE in cows and CJD in humans).

In conclusion, a variety of particular embodiments have been described in detail herein, but it will be appreciated that this is by way of exemplification only. The skilled person will be aware of many further potential modifications and adaptations that fall within the scope of the claimed invention and its equivalents.

1. A method of computer-assisted pharmaceutical investigation using a pharmaceutical knowledge base containing multiple information items stored in at least one computer, said method comprising:
providing axes representing pharmaceutical knowledge in a multi-dimensional coordinate space having at least a first axis pertaining to diseases, a second axis pertaining to targets, and a third axis pertaining to drug compounds; and
mapping pharmaceutical knowledge into the multi-dimensional coordinate space, wherein an information item is assigned one or more locations in the coordinate space, dependent upon the data contained within said information item.

2. The method of claim 1, wherein said pharmaceutical knowledge base includes a literature database of pharmaceutical, biological and medical research papers.

3. The method of claim 1, further comprising providing multiple entities along each axis, wherein each entity on the first axis is a disease, each entity on the second axis is a target, and each entity on the third axis is a compound.

4. The method of claim 3, further comprising allocating a unique identifier to each entity.

5. The method of claim 3, further comprising providing one or more ancillary parameters for at least some of said multiple entities.

6. The method of claim 5, wherein an ancillary parameter for a first entity on one axis provides a mapping to a second entity on another axis.

7. The method of claim 5, wherein an ancillary parameter provides one or more synonyms for the entity.

8. The method of claim 3, wherein assigning a location for an information item in the multi-dimensional coordinate space comprises identifying a link between the information item and two or more entities.

9. The method of claim 8, wherein identifying a link between an information item and an entity comprises performing a textual search of the information item for the name of the entity.

10. The method of claim 9, wherein identifying a link between an information item and an entity further comprises performing a textual search of the information item for any synonyms of the entity.

11. The method of claim 9, wherein identifying a link between an information item and an entity further comprises, if said entity is a compound, determining the names of compounds having a structural similarity to said entity, and performing a textual search of the information items for the names of said compounds having a structural similarity to said entity.

12. The method of claim 9, wherein identifying a link between an information item and an entity further comprises, if said entity is a target, determining the names of targets having a structural similarity to said entity, and performing a textual search of the information items for the names of said targets having a structural similarity to said entity.

13. The method of claim 9, further comprising computing said textual search for each entity along an axis and storing the results, wherein said stored results are used for responding to user queries.

14. A method of computer-assisted pharmaceutical investigation using a pharmaceutical knowledge base containing multiple information items stored in at least one computer, said method comprising:
storing at least a first set of named entities corresponding to one axis and a second set of named entities corresponding to another axis, wherein each entity incorporates a set of synonyms for the entity name, and wherein said axes are selected from different ones of a disease axis, a target axis, and a drug compound axis; and
searching the information items for a linkage between a specified entity on a first axis and each of the set of entities on a second axis, wherein said linkage is indicative of a potential pharmaceutical connection.

15. The method of claim 14, wherein a linkage is found between a first entity and a second entity if both the first and second entities are related to a single information item.

16. The method of claim 15, wherein an entity is related to an information item if the name or any synonym of the entity is present in the information item.

17. The method of claim 15, wherein an entity is related to an information item if the entity has a structural similarity to something in the information item.

18. The method of claim 14, wherein searching the information items for a linkage between said specified entity and an entity from the set of entities on the second axis comprises determining for each information item whether the information item contains both: (i) the name or any synonym of the specified entity; and (ii) the name or any synonym of said entity on the second axis.

19. The method of claim 18, further comprising presenting an output from said searching as a listing of the entities on the second axis.

20. The method of claim 19, wherein said listing omits entities on the second axis that do not have any linkage to the specified entity of the first axis.

21. The method of claim 19, wherein the entities on the second axis are ordered in the listing according to the number of information items for which there is a linkage between the specified entity and the entity on the second axis.

22. The method of claim 19, wherein said listing omits entities on the second axis that have a prerecorded linkage to the specified entity of the first axis.

23. The method of claim 22, wherein said prerecorded linkage between the specified entity and an entity on the second axis is stored as a parameter associated with said specified entity and/or said entity on the second axis.

24. The method of claim 19, further comprising:
generating the listing for each entity on the first axis,
storing data corresponding to the generated listings,
receiving a user query relating to a specified entity on the first axis, and
retrieving at least some of the stored data in order to provide a listing for the specified entity in response to the user query.

25. The method of claim 14, wherein said first axis is different from said second axis.

26. The method of claim 12, further comprising a third set of named entities corresponding to another axis, wherein said first set, second set and third set of entities correspond to different ones of a disease axis, a target axis, and a drug compound axis.

27. The method of claim 14, wherein the set of entities for at least one axis is substantially comprehensive for pharmaceutical knowledge relating to that axis.

28. The method of claim 27, wherein the set of entities for the drug compound axis is substantially comprehensive for compounds currently marketed or under development as drugs.

29. A method of computer-assisted pharmaceutical investigations comprising:
specifying a candidate hypothesis of the generic formula “A is related to B”, where A is selected from a first axis and B is selected from a second axis;
generating queries for investigating the candidate hypothesis in a systematic and comprehensive manner with respect to each possible value of B along the second axis; and
searching a pharmaceutical knowledge base containing multiple information items in accordance with said generated queries for evidence in support of the candidate hypothesis for each possible value of B along the second axis.

30. The method of claim 29, wherein said candidate hypothesis relates to the identification of compounds B that may be useful medicaments for the treatment of a disease A.

31. The method of claim 29, wherein said candidate hypothesis relates to the identification of targets B that may be useful for the treatment of a disease A.

32. The method of claim 29, wherein said candidate hypothesis relates to the identification of further disease indications B for a compound A that is known to be active against at least one other disease indication.

33. The method of claim 29, wherein said candidate hypothesis relates to the identification of further disease indications B for a target A that is known to be relevant to at least one other disease indication.

34. The method of claim 29, wherein said candidate hypothesis relates to the identification of compounds B that may be useful biomarkers or diagnostics for a disease A.

35. The method of claim 29, wherein said candidate hypothesis relates to the identification of compounds B that have no effect in relation to a disease A.

36. The method of claim 29, wherein said candidate hypothesis relates to the identification of compounds B that have an adverse effect in relation to a disease A.

37. The method of claim 29, wherein said candidate hypothesis relates to the identification of compounds B that have an interaction with a compound A for determining drug-drug synergies.

38. The method of claim 29, wherein said candidate hypothesis relates to the identification of compounds B that have an interaction with a compound A for determining drug-drug adverse effects.

39. The method of claim 29, wherein said candidate hypothesis relates to the identification of targets B that have a relationship with a target A.

40. The method of claim 29, wherein said candidate hypothesis relates to the identification of compounds B that have an interaction with a target A.

41. The method of claim 29, wherein said candidate hypothesis relates to the identification of targets B with which a compound A has an interaction.

42. The method of claim 29, wherein said candidate hypothesis relates to the identification of diseases B that have a co-occurrence relationship with a disease A.

43. The method of claim 29, wherein the pharmaceutical knowledge base comprises a single, combined or federated database of biomedical literature.

44. The method of claim 29, wherein said generated queries allow for synonyms of A and B.

45. The method of claim 44, further comprising storing synonyms for A and synonyms for B, and wherein a query in respect of A and B comprises multiple subqueries, one for each possible synonym combination of A and B.

46. The method of claim 29, further comprising:
performing said specifying, generating and searching for all possible values of A along the first axis;
storing the results; and
using said stored results to respond to ad hoc user investigations of candidate hypotheses.

47. The method of claim 29, further comprising filtering the values of B along said second axis prior to performing said searching.

48. The method of claim 47, wherein said filtering is performed using one or more ancillary parameters for values along the second axis.

49. The method of claim 47, wherein said second axis represents target, and wherein the values of B along said second axis are filtered to exclude those targets for which no drug compound has been launched.

50. The method of claim 47, wherein said second axis represents target, and wherein the values of B along said second axis are filtered to exclude those targets for which no orally administered drug compound is available.

51. The method of claim 47, wherein said second axis represents target, and the values of B along said second axis are filtered to exclude those targets having low druggability.

52. The method of claim 29, further comprising presenting an ordered listing of the values of B for which the generated queries provided evidence in support of the candidate hypothesis.

53. The method of claim 52, wherein the listing is ordered according to the number of information items that support the candidate hypothesis.

54. The method of claim 52, wherein the listing is ordered according to confidence in the candidate hypothesis.

55. The method of claim 54, further comprising using semantic processing to determine confidence.

56. The method of claim 52, wherein the B axis corresponds to compounds or targets, and the listing is ordered according to structural groupings.

57. The method of claim 29, further comprising ordering said second axis in accordance with a predefined ontology, and using statistical techniques to detect clusters of values for B that support said candidate hypothesis.

58. The method of claim 57, wherein the B axis corresponds to compounds, and said predefined ontology is based on structural similarities.

59. The method of claim 57, wherein the B axis corresponds to targets, and said predefined ontology is based on sequence similarities.

60. The method of claim 29, wherein searching the pharmaceutical knowledge base further includes filtering the information items by one or more criteria.

61. The method of claim 60, wherein said filtering is performed using a defined vocabulary of pharmacologically relevant keywords.

62. The method of claim 29, wherein the first axis corresponds to one of disease, target or compound, and the second axis corresponds to one of disease, target or compound.

63. The method of claim 62, wherein the target axis is derived from the list of genes and protein products expressed from one or more genomes.

64. The method of claim 62, wherein the compound axis is derived from drugs that are being marketed or are under public development.

65. The method of claim 64, wherein the target axis is derived from targets that are known to interact with compounds on the compound axis.

66. The method of claim 62, wherein the disease axis is derived from one or more dictionaries or encyclopaedias of diseases.

67. The method of claim 66, wherein the disease axis is filtered according to medical need.

68. The method of claim 29, wherein at least one of the first or second axes corresponds to anatomy.

69. The method of claim 29, wherein at least one of the first or second axes corresponds to cell type.

70. The method of claim 29, wherein at least one of the first or second axes corresponds to tissue type.

71. The method of claim 29, wherein at least one of the first or second axes corresponds to experimental procedure.

72. A method of computer-assisted pharmaceutical investigation using a pharmaceutical knowledge base containing multiple information items stored in at least one computer, said method comprising:
storing at least a first set of named entities corresponding to one axis and a second set of named entities corresponding to another axis, wherein each entity incorporates a set of synonyms for the entity name; and
searching the information items for a linkage between a specified entity on a first axis and each of the set of entities on a second axis, wherein said linkage is indicative of a potential pharmaceutical connection.

73. A method of manufacturing a drug for the treatment of a disease comprising the steps of:
identifying the drug as a potential treatment for the disease by:
specifying a candidate hypothesis of the generic formula “A is related to B”, where A is selected from a first axis and B is selected from a second axis, wherein said first and second axes are selected from disease, drug compound and target;
generating queries for investigating the candidate hypothesis in a systematic and comprehensive manner with respect to each possible value of B along the second axis; and
searching a pharmaceutical knowledge base containing multiple information items in accordance with said generated queries for evidence in support of the candidate hypothesis for each possible value of B along the second axis;
confirming by experiment that the drug can be used as a treatment for said disease; and
producing the drug as a treatment for the disease.

74. A method of determining a drug for the treatment of a disease comprising the steps of:
identifying the drug as a potential treatment for the disease by:
specifying a candidate hypothesis of the generic formula “A is related to B”, where A is selected from a first axis and B is selected from a second axis, wherein said first and second axes are selected from disease, drug compound and target;
generating queries for investigating the candidate hypothesis in a systematic and comprehensive manner with respect to each possible value of B along the second axis; and
searching a pharmaceutical knowledge base containing multiple information items in accordance with said generated queries for evidence in support of the candidate hypothesis for each possible value of B along the second axis; and
confirming by experiment that the drug can be used as a treatment for said disease.

75. A system for computer-assisted pharmaceutical investigation using a pharmaceutical knowledge base containing multiple information items stored in at least one computer, said system including a computer-based model having axes representing pharmaceutical knowledge in a multi-dimensional coordinate space having at least a first axis pertaining to diseases, a second axis pertaining to targets, and a third axis pertaining to drug compounds, wherein pharmaceutical knowledge is mapped into the multi-dimensional coordinate space by assigning an information item to one or more locations in the coordinate space, dependent upon the data contained within said information item.

76. The system of claim 75, wherein said pharmaceutical knowledge base includes a literature database of pharmaceutical, biological and medical research papers.

77. The system of claim 75, further comprising multiple entities along each axis, wherein each entity on the first axis is a disease, each entity on the second axis is a target, and each entity on the third axis is a compound.

78. The system of claim 77, wherein a unique identifier is allocated to each entity.

79. The system of claim 77, wherein one or more ancillary parameters are provided for at least some of said multiple entities.

80. The system of claim 79, wherein an ancillary parameter for a first entity on one axis provides a mapping to a second entity on another axis.

81. The system of claim 79, wherein an ancillary parameter provides one or more synonyms for the entity.

82. The system of claim 77, wherein a location for an information item in the multi-dimensional coordinate space is assigned by identifying a link between the information item and two or more entities.

83. The system of claim 82, wherein a link is identified between an information item and an entity by performing a textual search of the information item for the name of the entity.

84. The system of claim 83, wherein a link is identified between an information item and an entity by further performing a textual search of the information item for any synonyms of the entity.

85. The system of claim 83, wherein a link is identified between an information item and an entity, if said entity is a compound, by further determining the names of compounds having a structural similarity to said entity, and performing a textual search of the information items for the names of said compounds having a structural similarity to said entity.

86. The system of claim 83, wherein a link is identified between an information item and an entity, if said entity is a target, by further determining the names of targets having a structural similarity to said entity, and performing a textual search of the information items for the names of said targets having a structural similarity to said entity.

87. The system of claim 83, further comprising stored pre-computed results for said textual search for each entity along an axis, wherein said stored results are used for responding to user queries.

88. A system for computer-assisted pharmaceutical investigation using a pharmaceutical knowledge base containing multiple information items stored in at least one computer, said system comprising:
a storage facility providing at least a first set of named entities corresponding to one axis and a second set of named entities corresponding to another axis, wherein each entity incorporates a set of synonyms for the entity name, and wherein said axes are selected from different ones of a disease axis, a target axis, and a drug compound axis; and
a search engine for locating information items having a linkage between a specified entity on a first axis and each of the set of entities on a second axis, wherein said linkage is indicative of a potential pharmaceutical connection.

89. The system of claim 88, wherein a linkage is found between a first entity and a second entity if both the first and second entities are related to a single information item.

90. The system of claim 89, wherein an entity is related to an information item if the name or any synonym of the entity is present in the information item.

91. The system of claim 89, wherein an entity is related to an information item if the entity has a structural similarity to something present in the information item.

92. The system of claim 88, wherein the search engine locates information items having a linkage between said specified entity and an entity from the set of entities on the second axis by determining for each information item whether the information item contains both: (i) the name or any synonym of the specified entity; and (ii) the name or any synonym of said entity on the second axis.

93. The system of claim 92, wherein an output from the search engine is presented as a listing of the entities on the second axis.

94. The system of claim 93, wherein said listing omits entities on the second axis that do not have any linkage to the specified entity of the first axis.

95. The system of claim 93, wherein the entities on the second axis are ordered in the listing according to the number of information items for which there is a linkage between the specified entity and the entity on the second axis.

96. The system of claim 93, wherein said listing omits entities on the second axis that have a prerecorded linkage to the specified entity of the first axis.

97. The system of claim 96, wherein said prerecorded linkage between the specified entity and an entity on the second axis is stored as a parameter associated with said specified entity and/or said entity on the second axis.

98. The system of claim 93, further comprising stored precomputed data corresponding to generated listings for each entity on the first axis, wherein the stored, precomputed data is retrieved in order to provide a listing in relation to an entity specified in a user query.

99. The system of claim 88, wherein said first axis is different from said second axis.

100. The system of claim 88, wherein the storage facility further provides a third set of named entities corresponding to another axis, wherein said first set, second set and third set of entities correspond to different ones of a disease axis, a target axis, and a drug compound axis.

101. The system of claim 88, wherein the set of entities for at least one axis is substantially comprehensive for pharmaceutical knowledge relating to that axis.

102. The system of claim 101, wherein the set of entities for the drug compound axis is substantially comprehensive for compounds currently marketed or under development as drugs.

103. A computer-assisted system for investigating pharmaceutical candidate hypotheses of the generic formula “A is related to B”, where A is selected from a first axis, and B is selected from a second axis, said system comprising:
an application server for generating queries for investigating the candidate hypothesis in a systematic and comprehensive manner with respect to each possible value of B along the second axis; and
a search engine linked to a pharmaceutical knowledge base containing multiple information items, wherein the search engine utilises the generated queries for finding evidence in support of the candidate hypothesis for each possible value of B along the second axis.

104. The system of claim 103, wherein a candidate hypothesis relates to the identification of compounds B that may be useful medicaments for the treatment of a disease A.

105. The system of claim 103, wherein a candidate hypothesis relates to the identification of targets B that may be useful for the treatment of a disease A.

106. The system of claim 103, wherein a candidate hypothesis relates to the identification of further disease indications B for a compound A that is known to be active against at least one other disease indication.

107. The system of claim 103, wherein a candidate hypothesis relates to the identification of further disease indications B for a target A that is known to be relevant to at least one other disease indication.

108. The system of claim 103, wherein a candidate hypothesis relates to the identification of compounds B that may be useful biomarkers or diagnostics for a disease A.

109. The system of claim 103, wherein a candidate hypothesis relates to the identification of compounds B that have no effect in relation to a disease A.

110. The system of claim 103, wherein a candidate hypothesis relates to the identification of compounds B that have an adverse effect in relation to a disease A.

111. The system of claim 103, wherein a candidate hypothesis relates to the identification of compounds B that have an interaction with a compound A for determining drug-drug synergies.

112. The system of claim 103, wherein a candidate hypothesis relates to the identification of compounds B that have an interaction with a compound A for determining drug-drug adverse effects.

113. The system of claim 103, wherein a candidate hypothesis relates to the identification of targets B that have a relationship with a target A.

114. The system of claim 103, wherein a candidate hypothesis relates to the identification of compounds B that have an interaction with a target A.

115. The system of claim 103, wherein a candidate hypothesis relates to the identification of targets B with which a compound A has an interaction.

116. The system of claim 103, wherein a candidate hypothesis relates to the identification of diseases B that have a co-occurrence relationship with a disease A.

117. The system of claim 103, wherein the pharmaceutical knowledge base comprises a single, combined or federated database of biomedical literature.

118. The system of claim 97, wherein said generated queries allow for synonyms of A and B.

119. The system of claim 118, further comprising stored synonyms for A and for B, wherein a query in respect of A and B is split into multiple subqueries, one for each possible synonym combination of A and B.

120. The system of claim 103, further comprising stored results from performing said specifying, generating and searching for all possible values of A along the first axis, wherein the stored results are used to respond to ad hoc user investigations of candidate hypotheses.

121. The system of claim 103, wherein the values of B along said second axis are filtered prior to the searching.

122. The system of claim 121, wherein the filtering is performed using one or more ancillary parameters for values along the second axis.

123. The system of claim 121, wherein said second axis represents target, and wherein the values of B along said second axis are filtered to exclude those targets for which no drug compound has been launched.

124. The system of claim 121, wherein said second axis represents target, and wherein the values of B along said second axis are filtered to exclude those targets for which no orally administered drug compound is available.

125. The system of claim 121, wherein said second axis represents target, and the values of B along said second axis are filtered to exclude those targets having low druggability.

126. The system of claim 103, further comprising a client interface for presenting an ordered listing of the values of B for which the generated queries provided evidence in support of the candidate hypothesis.

127. The system of claim 126, wherein the listing is ordered according to the number of information items that support the candidate hypothesis.

128. The system of claim 126, wherein the listing is ordered according to confidence in the candidate hypothesis.

129. The system of claim 128, wherein semantic processing is used to determine confidence.

130. The system of claim 126, wherein the B axis corresponds to compounds or targets, and the listing is ordered according to structural groupings.

131. The system of claim 103, wherein the second axis is ordered in accordance with a predefined ontology, and a statistical analysis facility is provided to detect clusters of values for B that support said candidate hypothesis.

132. The system of claim 131, wherein the B axis corresponds to compounds, and said predefined ontology is based on structural similarities.

133. The system of claim 131, wherein the B axis corresponds to targets, and said predefined ontology is based on sequence similarities.

134. The system of claim 103, wherein the search engine filters the information items within the pharmaceutical knowledge base by one or more criteria.

135. The system of claim 134, wherein said filtering is performed using a defined vocabulary of pharmacologically relevant keywords.

136. The system of claim 103, wherein the first axis corresponds to one of disease, target or compound, and the second axis corresponds to one of disease, target or compound.

137. The system of claim 136, wherein the target axis is derived from the list of genes and protein products expressed from one or more genomes.

138. The system of claim 136, wherein the compound axis is derived from drugs that are being marketed or are under public development.

139. The system of claim 138, wherein the target axis is derived from targets that are known to interact with compounds on the compound axis.

140. The system of claim 136, wherein the disease axis is derived from one or more dictionaries and encyclopaedias of diseases.

141. The system of claim 140, wherein the disease axis is filtered according to medical need.

142. The system of claim 103, wherein at least one of the first or second axes corresponds to anatomy.

143. The system of claim 103, wherein at least one of the first or second axes corresponds to cell type.

144. The system of claim 103, wherein at least one of the first or second axes corresponds to tissue type.

145. The system of claim 103, wherein at least one of the first or second axes corresponds to experimental procedure.

146. A system for computer-assisted pharmaceutical investigation using a pharmaceutical knowledge base containing multiple information items stored in at least one computer, said system comprising:
a storage facility providing at least a first set of named entities corresponding to one axis and a second set of named entities corresponding to another axis, wherein each entity incorporates a set of synonyms for the entity name; and
a search engine for locating information items having a linkage between a specified entity on a first axis and each of the set of entities on a second axis, wherein said linkage is indicative of a potential pharmaceutical connection.

147. A computer program product for use in computer-assisted pharmaceutical investigations involving a pharmaceutical knowledge base containing multiple information items, said computer program product comprising program instructions on a medium, said instructions when loaded into a system causing the system to:
provide axes representing pharmaceutical knowledge in a multi-dimensional coordinate space having at least a first axis pertaining to diseases, a second axis pertaining to targets, and a third axis pertaining to drug compounds; and
map pharmaceutical knowledge into the multi-dimensional coordinate space, wherein an information item is assigned one or more locations in the coordinate space, dependent upon the data contained within said information item.

148. A computer program product for use in computer-assisted pharmaceutical investigations involving a pharmaceutical knowledge base containing multiple information items stored in at least one computer, said computer program product comprising program instructions on a medium, said instructions when loaded into a system causing the system to:
store at least a first set of named entities corresponding to one axis and a second set of named entities corresponding to another axis, wherein each entity incorporates a set of synonyms for the entity name; and
search the information items for a linkage between a specified entity on a first axis and each of the set of entities on a second axis, wherein said linkage is indicative of a potential pharmaceutical connection.

149. The computer program product of claim 148, wherein said axes are selected from different ones of a disease axis, a target axis, and a drug compound axis

150. A computer program product for use in computer-assisted pharmaceutical investigations, said computer program product comprising program instructions on a medium, said instructions when loaded into a system causing the system to:
accept a candidate hypothesis of the generic formula “A is related to B”, where A is selected from a first axis and B is selected from a second axis;
generate queries for investigating the candidate hypothesis in a systematic and comprehensive manner with respect to each possible value of B along the second axis; and
search a pharmaceutical knowledge base containing multiple information items in accordance with said generated queries for evidence in support of the candidate hypothesis for each possible value of B along the second axis.

151. The computer program product of claim 150, where the first axis corresponds to one of disease, target or compound, and the second axis corresponds to one of disease, target or compound

152. Apparatus for use in computer-assisted pharmaceutical investigations involving a pharmaceutical knowledge base containing multiple information items, said apparatus comprising:
means for providing axes representing pharmaceutical knowledge in a multi-dimensional coordinate space having at least a first axis pertaining to diseases, a second axis pertaining to targets, and a third axis pertaining to drug compounds; and
means for mapping pharmaceutical knowledge into the multi-dimensional coordinate space, wherein an information item is assigned one or more locations in the coordinate space, dependent upon the data contained within said information item.

153. Apparatus for use in computer-assisted pharmaceutical investigations involving a pharmaceutical knowledge base containing multiple information items stored in at least one computer, said apparatus comprising:
means for storing at least a first set of named entities corresponding to one axis and a second set of named entities corresponding to another axis, wherein each entity incorporates a set of synonyms for the entity name; and
means for searching the information items for a linkage between a specified entity on a first axis and each of the set of entities on a second axis, wherein said linkage is indicative of a potential pharmaceutical connection.

154. The apparatus of claim 153, wherein said axes are selected from different ones of a disease axis, a target axis, and a compound axis

155. Apparatus for use in computer-assisted pharmaceutical investigations, said apparatus comprising:
means for specifying a candidate hypothesis of the generic formula “A is related to B”, where A is selected from a first axis and B is selected from a second axis;
means for generating queries for investigating the candidate hypothesis in a systematic and comprehensive manner with respect to each possible value of B along the second axis; and
means for searching a pharmaceutical knowledge base containing multiple information items in accordance with said generated queries for evidence in support of the candidate hypothesis for each possible value of B along the second axis.

156. The apparatus of claim 155, where the first axis corresponds to one of disease, target or compound, and the second axis corresponds to one of disease, target or compound.
